(19) United States
(12) Patent Application Publication
(10) Pub. No.: US 2024/0375000 A1
(43) Pub. Date: Nov. 14, 2024

(54) METHOD AND APPARATUS FOR PROVIDING GAME SERVICE

(71) Applicant: NEXON KOREA CORPORATION, Seongnam-si (KR)

(72) Inventor: Dae Hyun KANG, Seongnam-si (KR)

(21) Appl. No.: 18/661,973

(22) Filed: May 13, 2024

(30) Foreign Application Priority Data
May 12, 2023 (KR) 10-2023-0061941
Nov. 23, 2023 (KR) 10-2023-0164846

(51) Int. Cl. A63F 13/53; A63F 13/65; A63F 13/812

(52) U.S. Cl. CPC A63F 13/53; A63F 13/65; A63F 13/812

(57) ABSTRACT

Provided is a method including obtaining prerequisite information pre-defined for playing a game, obtaining first content produced by setting a specific person as a recipient, based on the prerequisite information, requesting an external server configured to provide an external service, to display the first content through the external service, obtaining a first answer input by a user, based on the first content, and providing a game service controlled based on the first answer.

### CROSS-REFERENCE TO RELATED APPLICATIONS

This application is based on and claims priority under 35 U.S.C. § 119 to Korean Patent Application No. 10-2023-0061941, filed on May 12, 2023, and Korean Patent Application No. 10-2023-0164846, filed on Nov. 23, 2023, in the Korean Intellectual Property Office, the disclosures of which are incorporated by reference herein in their entirety.

### BACKGROUND

### 1. Field

The disclosure relates to a method and apparatus for providing a game service.

### 2. Description of the Related Art

Recently, many games of various genres have been developed, leading to an explosive increase in users. With the development of games of various genres and improvement in performance of devices for playing games, gaming has emerged as a mainstream hobby.

Game service providers provide various types of game content to users playing games. However, game service providers commonly require the use of game clients to provide game content. Users may access game services by executing game clients and play the games through the game clients.

A game client is software for executing and playing a game. A game client provides an environment required to play a game. A game client operates in a user terminal and may transmit or receive data related to a game by communicating with a game server. Generally, game clients may be provided in the form of an application operating in a device, such as a personal computer (PC), a games console, a smartphone, or a tablet PC.

### SUMMARY

Provided are a method and apparatus for providing a game service, in which immersion of users in a game may be improved without a separate game client.

Additional aspects will be set forth in part in the description which follows and, in part, will be apparent from the description, or may be learned by practice of the presented embodiments of the disclosure.

According to an aspect of the disclosure, a method by which a game-providing apparatus provides a game service, includes obtaining prerequisite information pre-defined for playing a game, obtaining first content produced by setting a specific person as a recipient, based on the prerequisite information, requesting an external server configured to provide an external service, to display the first content through the external service, obtaining a first answer input by a user, based on the first content, and providing a game service controlled based on the first answer.

According to another aspect of the disclosure, a game-providing apparatus includes a memory storing instructions, and at least one processor functionally connected to the memory and configured to execute the instructions to obtain prerequisite information pre-defined for playing a game, obtain first content produced by setting a specific person as a recipient, based on the prerequisite information, request an external server configured to provide an external service, to display the first content through the external service, obtain a first answer input by a user, based on the first content, and provide a game service controlled based on the first answer.

According to another aspect of the disclosure, a server includes a memory storing instructions, and at least one processor functionally connected to the memory and configured to execute the instructions to obtain prerequisite information pre-defined for playing a game, obtain first content produced by setting a specific person as a recipient, based on the prerequisite information, request an external server configured to provide an external service, to display the first content through the external service, obtain a first answer input by a user, based on the first content, and provide a game service controlled based on the first answer.

According to another aspect of the disclosure, a user terminal for providing a game service, includes a user input unit configured to receive a user input, a memory storing instructions, and at least one processor functionally connected to the user input unit and the memory, and configured to execute the instructions to obtain prerequisite information pre-defined for playing a game, obtain first content produced by setting a specific person as a recipient, based on the prerequisite information, request an external server configured to provide an external service, to display the first content through the external service, obtain a first answer input by a user, based on the first content, and provide a game service controlled based on the first answer.

According to another aspect of the disclosure, a computer-readable recording medium has recorded thereon a program for executing, on a computer, the method of providing a game service.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a game providing system including a server and a user terminal, according to some embodiments;

FIG. 2 is a conceptual diagram for describing a method of providing a game service, according to an embodiment;

FIG. 3 is a flowchart of a method of providing a game service, according to an embodiment;

FIG. 4 is a flowchart of a method of providing a game service, according to an embodiment;

FIG. 5 is a diagram for describing prerequisite information pre-defined for playing a game, according to an embodiment;

FIG. 6 is a diagram illustrating a user interface for describing an operation of displaying content through an external service, according to an embodiment;

FIG. 7 is a diagram illustrating a user interface for describing an operation of displaying an answer according to displayed content, according to an embodiment;

FIG. 8 is a diagram illustrating a user interface for describing an operation of displaying content through an external service, according to an embodiment;

FIG. 9 is a diagram illustrating a user interface for describing an operation of displaying an answer according to displayed content, according to an embodiment;

FIG. 10 is a diagram illustrating a user interface for describing an operation of displaying content through an external service, according to an embodiment;

FIG. 11 is a diagram illustrating a user interface for describing an operation of displaying an answer according to displayed content, according to an embodiment;

FIG. 12 is a flowchart of a method of providing a game service, according to an embodiment;

FIG. 13 is a diagram illustrating a user interface for describing an operation of communicating as content and an answer are repeatedly obtained, according to an embodiment;

FIG. 14 is a flowchart of a method of providing a game service, according to an embodiment;

FIG. 15 is a diagram illustrating a user interface for describing an operation of displaying content through an external service, according to some embodiments;

FIG. 16 is a diagram illustrating a user interface for describing an operation of displaying content through an external service, according to some embodiments;

FIG. 17 is a diagram illustrating a user interface for describing an operation of displaying an answer according to displayed content, according to some embodiments;

FIG. 18 is a flowchart of a method of providing a game service, according to some embodiments;

FIG. 19 is a diagram illustrating a user interface for describing an operation of displaying pre-content before an operation of communicating as content and answers are obtained is performed, according to some embodiments;

FIG. 20 is a flowchart of a method of providing a game service, according to an embodiment;

FIG. 21 is a diagram for describing a specific configuration of a game-providing apparatus, according to some embodiments;

FIG. 22 is a diagram for describing a specific configuration of a server, according to some embodiments; and

FIG. 23 is a diagram for describing a specific configuration of a user terminal, according to some embodiments.

### DETAILED DESCRIPTION

Hereinafter, embodiments will be described in detail with reference to content shown in accompanying drawings. Also, methods of configuring and using a game-providing apparatus according to an embodiment will be described in detail with reference to the content shown in the accompanying drawings. Like reference numerals or signs in the drawings denote parts or components substantially performing same functions.

While terms including ordinal numbers, such as “first”, “second”, etc., may be used to describe various components, such components are not limited to the above terms. The above terms are used only to distinguish one element from another. For example, without departing from the scope of the rights described in the disclosure, a first component may be referred to as a second component, and similarly, a second component may be referred to as a first component. The term “and/or” includes a combination of a plurality of related items or one item from among the plurality of related items. Expressions such as “at least one of,” when preceding a list of elements, modify the entire list of elements and do not modify the individual elements of the list.

Also, the terms used in the present specification are only used to describe embodiments, and are not intended to limit and/or restrict the disclosure. An expression used in the singular encompasses the expression in the plural, unless it has a clearly different meaning in the context. In the present specification, it is to be understood that terms such as “including” or “having”, etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Throughout the specification, when a part is “connected” to another part, the part may not only be “directly connected” to the other part, but may also be “electrically connected” to the other part with another element in between. In addition, when a part “comprises (includes)” a certain element, the part may further include another element instead of excluding the other element, unless otherwise stated. In addition, terms such as “unit”, “-or/-er”, and “module” described in the specification denote a unit that processes at least one function or operation, which may be implemented in hardware or software, or implemented in a combination of hardware and software.

A game-providing apparatus of the disclosure below may be a game server, a user terminal, a game system including the game server and the user terminal, or an independent apparatus.

In the disclosure below, a server controlling a user terminal may indicate that the server communicates with the user terminal to control an output (any output device in the user terminal, such as screen display, sound output, vibration output, and lamp illumination) of the user terminal and provide data for the user terminal to perform a certain operation. Obviously, the user terminal may control an output of the user terminal by using pre-stored data and the disclosure is not limited to the above examples.

In the disclosure below, transmitting and receiving information or data with a user (or a user account) may indicate that information or data is transmitted and received to and from a device (or a user terminal) corresponding to or linked to the user (or the user account).

In the disclosure below, a user, a player, a user account, and a gamer may be used in a same meaning. In the disclosure, it should be understood that a user terminal may indicate a user, a player, a user account, or a gamer, or a device used by the user, the player, the user account, or the gamer, according to context. In the disclosure, it should be understood that a user, a player, a user account, or a gamer may indicate an avatar or a character manipulated by the user, the player, the user account, or the gamer, or a device used by the user, the player, the user account, or the gamer, according to context.

In the disclosure below, a game service may indicate a game provided by a game-providing apparatus according to some embodiments. In general, a user may access a game service by executing a game client, but a game-providing apparatus according to an embodiment may provide a game service to a user without having to execute a separate game client.

In the disclosure below, an external service may denote a service that is not provided by a game-providing apparatus according to some embodiments. The external service may be distinguished from a game service. The external service may be provided by an external server operated separately from the game-providing apparatus. For example, the external service may include a service for providing convenience to a user, such as a video providing service, a messenger service, a web search service, a calendar service, an email service, or a social network service (SNS).

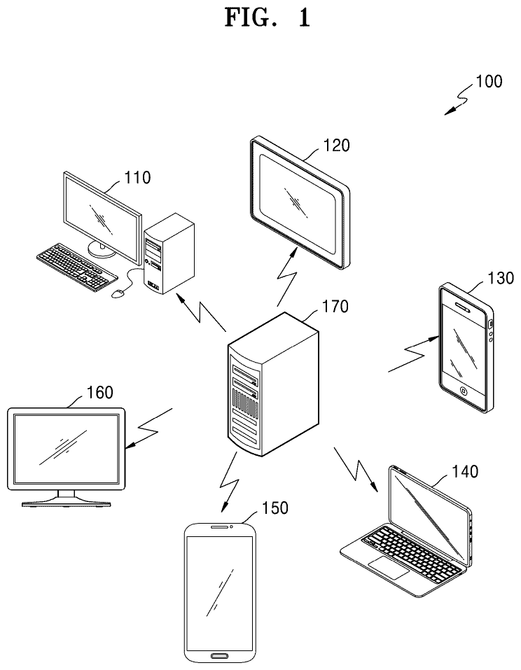

FIG. 1 illustrates a game providing system 100 including a server 170 and a user terminal, according to some embodiments.

The game providing system 100 of the disclosure may include the server 170 and at least one of user terminals 110 to 160. The server 170 may provide various online activities through a network. The server 170 may provide an online activity simultaneously to at least one of the user terminals 110 to 160.

According to an embodiment, the server 170 may include a single server, an array of servers, or a cloud server, but is not limited thereto. The server 170 provides various online activities and may include a database storing data for the online activities. Also, the server 170 may include a payment server configured to generate and process a payment event. As described above, the server 170 may be a game-providing apparatus.

According to an embodiment, a network denotes connection established (or formed) by using any communication method, and may indicate a communication network connected through any communication method, which transmits and receives data between terminals or between a terminal and a server.

Any communication method may include all communication methods, such as communication through a certain communication standard, a certain frequency band, a certain protocol, and a certain channel. For example, any communication method may include communication methods through Bluetooth, Bluetooth low energy (BLE), Wi-Fi, ZigBee, 3rd generation (3G), long-term evolution (LTE), and ultrasonic waves, and may include all of short-range communication, long-range communication, wireless communication, and wired communication. However, the communication method is not limited to the above examples.

According to an embodiment, a short-range communication method may denote a communication method in which communication is possible only when a device (a terminal or a server) performing communication is within a specific range, and may include, for example, Bluetooth or near field communication (NFC). A long-range communication method may denote a communication method in which a device performing communication is able to perform communication regardless of a distance. For example, the long-range communication method may denote a method by which two devices performing communication through a relay, such an access point (AP), perform communication even when the two devices are separated by a certain distance or greater, and may include a communication method using a cellular network (3G or LTE), such as a short message service (SMS) or a phone call. However, the long-range communication method is not limited to the above examples. Receiving of an online activity by using a network may indicate that communication may be performed between a server and a terminal through any communication method.

Throughout the specification, at least one of the user terminals 110 to 160 may include not only a personal computer (PC) 110, a tablet PC 120, a cellular phone 130, a laptop computer 140, a smartphone 150, and a television (TV) 160, but also various electronic devices, such as a personal digital assistant (PDA), a portable multimedia player (PMP), a navigation device, an MP3 player, a digital camera, a refrigerator, a washing machine, and a vacuum cleaner, but is not limited thereto. As described above, at least one of the user terminals 110 to 160 may be the game-providing apparatus.

According to an embodiment, the online activity may include an online game, a portal service, or a social network service (SNS), but is not limited thereto. Also, the online game may include any genre, such as massive multi-user online role playing game (MMORPG), aeon of strife (AOS), first person shooter (FPS), trading card game (TCG), or collectible card game (CCG). The online game may be a game pitting users against each other or a game pitting a user against a computer (e.g., artificial intelligence). Obviously, the online game is not limited thereto, and a type of the online game is not limited.

The game providing system 100 according to an embodiment may obtain prerequisite information pre-defined for playing a game, and obtain content produced by setting a specific person as a recipient, based on the prerequisite information. The game providing system 100 may request an external server to display the obtained content through an external service. The game providing system 100 may obtain a user input of an answer based on the displayed content and control the game, based on the answer.

According to an embodiment, the server 170 may obtain the prerequisite information pre-defined for playing the game, and obtain the content produced by setting the specific person as the recipient, based on the prerequisite information. The server 170 may request the external server to display the obtained content through the external service. The server 170 may obtain the user input of the answer based on the displayed content and control the game, based on the answer.

According to an embodiment, one of the user terminals 110 to 160 may obtain the prerequisite information pre-defined for playing the game, obtain the content produced by setting the specific person as the recipient, based on the prerequisite information, and request the external server to display the obtained content through the external service. One of the user terminals 110 to 160 may obtain the user input of the answer, based on the displayed content, and control the game, based on the answer.

According to an embodiment, some or all of operations of the server 170 may be performed by the user terminals 110 to 160. For example, according to some embodiments, a method of providing a game service may be performed by the user terminals 110 to 160 without communicating with the server 170.

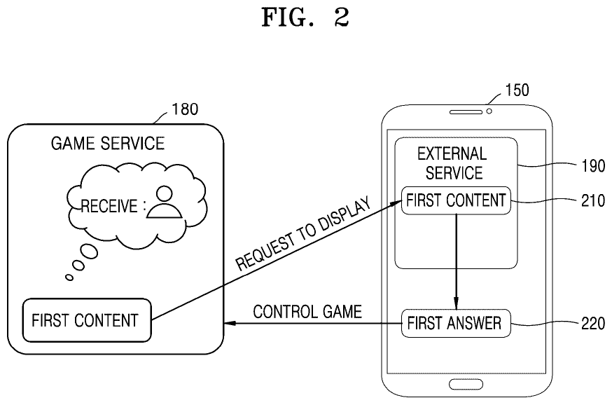

FIG. 2 is a conceptual diagram for describing a method of providing the game service 180, according to an embodiment.

Referring to FIG. 2, a game-providing apparatus may display content to a user through an external service 190 and provide the game service 180 based on an answer of the user to the content. For example, the game-providing apparatus may transmit a message to the user through a chatting application and control a game, based on an answer of the user to the transmitted message.

According to an embodiment, the game-providing apparatus may obtain prerequisite information. The prerequisite information may be information pre-defined for playing the game. The game-providing apparatus may pre-define the prerequisite information to play the game and store the same in a memory. The prerequisite information may be information about a game environment set to play the game.

For example, the game-providing apparatus may provide a game service of a soccer sports genre. The game-providing apparatus may obtain, as the prerequisite information, data about a game schedule of a soccer tournament to play a provided soccer game. The game-providing apparatus may provide the game service according to the provided game schedule of the soccer tournament, based on the obtained prerequisite information.

As another example, the game-providing apparatus may obtain, as the prerequisite information, data about soccer players and a team in the game to play the soccer game. In other words, the game-providing apparatus may pre-define a team and players in the team, which are selectable by the user. According to an embodiment, the game-providing apparatus may reflect information about actual soccer teams and actual soccer players to the prerequisite information, and store the same. The game-providing apparatus may provide the game service 180 using the provided data about the soccer players and soccer teams, based on the obtained prerequisite information.

According to an embodiment, the game-providing apparatus may obtain first content 210. The first content 210 may include at least one of an image, video, text, and speech.

For example, the first content 210 may be video content uploaded in a video platform in which users may freely upload or view a moving image. In this case, the external service 190 providing the first content 210 may be the video platform.

As another example, the first content 210 may be text content. For example, the first content 210 may include content configured in text, such as email content, message content, or article content.

As another example, the first content 210 may be image content. Also, the first content 210 may be content in which an image and text are combined. For example, the first content 210 may be article content configured with an image and text.

According to an embodiment, the first content 210 may include content configured with a combination of at least two of an image, video, text, and speech. For example, the first content 210 may be video content uploaded in the video platform, and obviously, may include speech according to video.

According to an embodiment, the first content 210 may be content produced by setting a specific person as a recipient.

An online game provided by the game-providing apparatus may include any genre, such as sports, simulation game, MMORPG, or AOS. For convenience of description, the disclosure will be described with an example of a soccer game among sports games. According to an embodiment, the game-providing apparatus may obtain the first content 210 produced by setting the specific person as the recipient. The game-providing apparatus may obtain the first content 210 in which a person holding a position as a soccer coach is the recipient. For example, the game-providing apparatus may obtain, as the first content 210, a message to be transmitted to the person holding a position as a soccer coach. As another example, the game-providing apparatus may obtain, as the first content 210, a soccer team training video to be transmitted to the person holding a position as a soccer coach.

According to an embodiment, the first content 210 may be obtained by an artificial intelligence model. The artificial intelligence model may be an interactive artificial intelligence model. The artificial intelligence model may be a model that performs learning based on massive text data to output data, for example, answer to a question or provide information through conversation with the user. The game-providing apparatus may obtain text content as the first content 210 by using the artificial intelligence model.

The game-providing apparatus may convert the obtained text content into speech, by using a text-to-speech (TTS) algorithm. The game-providing apparatus may obtain the speech as the first content 210. However, such a method of obtaining speech content is only an example and is not limited thereto, and the speech content may be obtained as the first content 210 by the artificial intelligence model configured to generate speech appropriate to a situation, based on data.

The artificial intelligence model may be a model that performs learning based on massive text data and video data to output video appropriate to a situation, through conversation with the user. The game-providing apparatus may obtain video content as the first content 210 by using the artificial intelligence model.

According to an embodiment, the game-providing apparatus may obtain first content 210, based on the prerequisite information. The game-providing apparatus may obtain the first content 210, based on a game environment set according to the prerequisite information.

For example, the game-providing apparatus may obtain the first content 210 produced by setting a soccer player defined through the prerequisite information, as the recipient. In detail, for example, the game-providing apparatus may obtain, as the first content 210, a message transmitted from a soccer player defined in the game environment. The first content 210 is displayed to the user, and thus, the game-providing apparatus may cause natural communication between the user and a virtual character in the game environment. The game-providing apparatus may improve immersion of the user in the provided game service.

According to an embodiment, the game-providing apparatus may request an external server configured to provide the external service 190, to display the first content 210 through the external service 190.

The external service 190 may include a messenger platform providing a message transmitting function between users, a video platform providing a moving image uploading and viewing function, an SNS, a search portal service, and an email service.

The first content 210 displayable in the messenger platform may be message content. The first content 210 displayable in the video platform may be video content. The first content 210 displayable in the SNS may include message content and uploaded post content. The first content 210 displayable in the search portal service may include Internet article content and content uploaded in a blog. The first content 210 displayable in the email service may include email content.

According to an embodiment, the game-providing apparatus may request the external server to display the first content 210 through the external service 190. The game-providing apparatus may request the external server configured to provide the external service 190 to display the first content 210 on the user terminal 150 accessing the external service 190. For example, the first content 210 may be displayed on a display of the user terminal 150.

According to an embodiment, the game-providing apparatus may obtain a first answer 220 through the user terminal 150. The first answer 220 may be a user input that is input by the user, based on the first content 210. The first answer 220 may be a user input that is input through the user terminal 150.

The first answer 220 may include at least one of text and speech. For example, the first answer 220 may be text data obtained through an interface of the user terminal 150. As another example, the first answer 220 may be speech data of the user, which is recognized through the user terminal 150.

Some or all of operations of the game-providing apparatus may be performed by the user terminal 150.

According to an embodiment, the game-providing apparatus may obtain, from the external server, user information about the user who subscribed to the external service 190 and provide the first content 210 to the subscribed user according to the user information.

The external server providing the external service 190 may store pieces of information about various users who subscribed to the external service 190. An operation of subscribing to the external service 190 may vary according to the form of user interface/user experience (UI/UX) provided by each service. For example, to subscribe to the external service 190, the user may join the external service 190 as a member through a member subscription page provided by the external service 190.

For example, the user information may include personal information about the user, such as email address information, mobile phone information, address information, and phone number information.

The game-providing apparatus may request the external server for the user information about the user who subscribed to the external service 190 and receive the requested user information from the external server. The game-providing apparatus may provide the first content 210, based on the received user information.

For example, the game-providing apparatus may provide a game service of soccer. The game-providing apparatus may provide, as the first content 210, an email proposing the user to recruit a specific player, according to the received user information, to perform the game service.

As another example, the game-providing apparatus may obtain the phone number information as the user information and provide the user with speech content as the first content 210, based on the phone number information. In this case, for example, the speech content may be speech data obtained by converting content in the form of text, by using a TTS method. Also, when the game-providing apparatus obtains a speech answer as the first answer 220 to the first content 210, the game-providing apparatus may process the speech answer by using a speech recognition technology.

According to an embodiment, the first content 210 may include content proposing the user to participate in the game service 180 provided by the game-providing apparatus. For example, the first content 210 may be provided to the user through the external service 190, such as an email, a messenger, or a phone. When the game-providing apparatus receives the first answer 220 including content accepting to participate in the game service 180, the game-providing apparatus may start to provide the game service 180 with the user as a target.

According to an embodiment, the game-providing apparatus may provide the game service 180 controlled based on the first answer 220. The game-providing apparatus may change controllable information that may be controlled by the user to play a game. For example, the game-providing apparatus may change the controllable information, such as game settings, standards, direction, and plan, which affects the game. For example, in a case of a soccer sports game, the game-providing apparatus may obtain the first answer 220 indicating that a striker should more actively pressure an opposite defender, and change a direction of action of the striker during a soccer game, based on the first answer 220. The game-providing apparatus may provide the game service 180, based on the changed controllable information. The game-providing apparatus may provide, as the game service 180, the soccer game in which the striker more actively pressures the opposite defender.

As another example, the game-providing apparatus may obtain the first answer 220 indicating that all soccer team players should conduct a training session, and change a game plan such that the training session is conducted based on the first answer 220. The game-providing apparatus may provide the game service 180 controlled based on the changed controllable information. The game-providing apparatus may provide, as the game service 180, controlled game content in which the soccer team players conduct the training session.

According to an embodiment, the controllable information may be information controllable by the user to play the game. For example, the controllable information may include information, such as game settings, standards, direction, and plane, which affects the game.

According to an embodiment, the controllable information may be included in the prerequisite information. For example, the prerequisite information may include information about a behavior pattern of a character that is basically set to play the game. The behavior pattern of the character may be controlled by the user during the game, and the controllable information may include information about the behavior pattern of the character. As another example, the prerequisite information may include information about a start date of the game set to play the game. The information about the start date of the game may be information uncontrollable by the user.

In other words, according to an embodiment, the prerequisite information may denote information in a range including the controllable information.

The game-providing apparatus according to an embodiment may display the first content 210 through the external service 190 and control the game, based on the first answer 220 corresponding to the first content 210. Accordingly, the game-providing apparatus may control the game of the game service 180 through the external service 190 operated separately from the game service 180. When the external service 190 is a search portal, video platform, or messenger service, which is easily accessible by users in everyday lives, the users play the game in everyday lives without being conscious of the game. The game-providing apparatus provides the game service 180 such that a boundary between the game and reality is blurred, thereby improving immersion of the user.

Also, the game-providing apparatus obtains the first content 210 received from a virtual character and controls the first content 210 to be displayed through the external service 190. The user is unable to distinguish whether a sender of the first content 210 displayed through the external service 190 is a virtual character or a real life person, and thus, the user may receive the game service 180 with higher immersion.

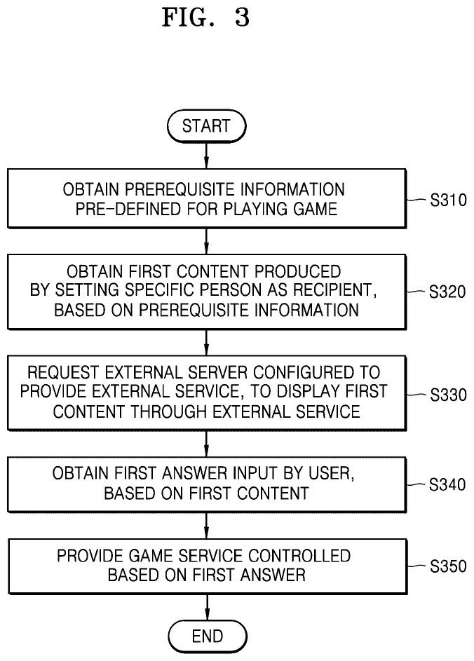

FIG. 3 is a flowchart of a method of providing a game service, according to an embodiment.

Referring to FIG. 3, in operation S310, the game-providing apparatus may obtain prerequisite information pre-defined for playing a game.

According to an embodiment, the game-providing apparatus may pre-define the prerequisite information to play the game and store the same in a memory. The game-providing apparatus may obtain the prerequisite information from the memory. According to an embodiment, the game-providing apparatus may obtain prerequisite information from a separate server.

According to an embodiment, the prerequisite information may be information about a game environment set to play the game. For example, the game-providing apparatus may provide a game service of a soccer sports genre. The game-providing apparatus may obtain, as the prerequisite information, data about a game schedule of a soccer tournament to play a provided soccer game. The game-providing apparatus may provide the game service according to the provided game schedule of the soccer tournament, based on the obtained prerequisite information.

In operation S320, the game-providing apparatus may obtain first content produced by setting a specific person as a recipient, based on the prerequisite information.

According to an embodiment, the first content may include at least one of an image, video, text, and speech. The first content may include a combination of at least two of an image, video, text, and speech.

According to an embodiment, the first content may be content produced by setting the specific person as the recipient. For example, when the game-providing apparatus according to an embodiment provides a soccer game service, the first content may be content produced by setting a person holding a position as a soccer coach as the recipient. The game-providing apparatus may obtain the first content transmitted to the person holding a position as a soccer coach.

According to an embodiment, the first content may be information obtained based on the prerequisite information. For example, the game-providing apparatus may provide the game service of the soccer sports genre, and the prerequisite information may include data about the game schedule of the soccer tournament for progressing a virtual soccer tournament in the game. The game-providing apparatus may obtain, as the first content, a message indicating how to form a starting list of players of a first game, ahead of the first game during the game schedule of the soccer tournament.

In operation S330, the game-providing apparatus may request an external server configured to provide an external service, to display the first content through the external service.

According to an embodiment, the external service may be provided by the external server operated separately from the game-providing apparatus. For example, the external service may include a service for providing convenience to a user, such as a video providing service, a messenger service, a web search service, a calendar service, an email service, or a SNS.

The game-providing apparatus may request the external server configured to provide the external service, to display the first content through the external service. The game-providing apparatus may request the external server to display the first content through a user terminal. Based on the request, the first content may be displayed through the user terminal.

For example, when the game-providing apparatus according to an embodiment provides the soccer game service, the first content may be content produced by setting the person holding a position as a soccer coach as the recipient. The first content obtained by the game-providing apparatus may be displayed to a user receiving the game service through the user terminal. Accordingly, the user receiving the game service by the game-providing apparatus according to an embodiment may experience a virtual life as a soccer coach.

In operation S340, the game-providing apparatus may obtain a first answer input by the user, based on the first content.

According to an embodiment, the first answer may include at least one of text and speech.

According to an embodiment, the first answer may be a user input that is input through an interface of the user terminal. The game-providing apparatus may obtain the first answer from the user terminal, and obviously, some or all of operations of the user terminal may be included in operations of the game-providing apparatus.

According to an embodiment, the first answer may be stored and displayed through the external service. The game-providing apparatus may request the external server to transmit the first answer and obtain the first answer from the external server. The game-providing apparatus may receive, from the external server, the first answer obtained in the external service.

In operation S350, the game-providing apparatus may provide the game service controlled based on the first answer.

According to an embodiment, the game-providing apparatus may change information, such as game settings, standards, direction, and plan, which affects the game. For example, the first answer may include information instructing to change the direction of the game. In detail, in a case of the soccer sports game, the game-providing apparatus may obtain the first answer instructing a striker to actively pressure an opposite defender, based on the first content. The game-providing apparatus may change the direction of the game, based on the obtained first answer.

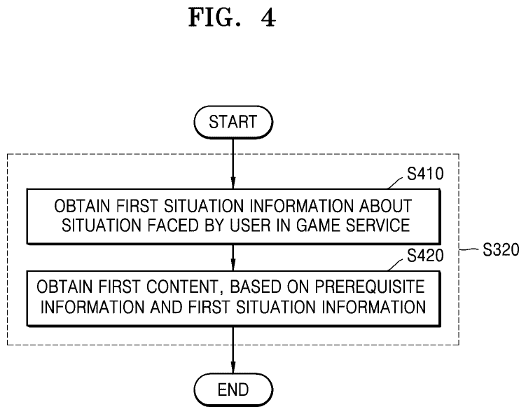

FIG. 4 is a flowchart of a method of providing a game service, according to an embodiment. For convenience of description, details that overlap those described with reference to FIG. 3 will be briefly described or omitted.

Referring to FIG. 4, operation S320 of FIG. 3 may include operations S410 and S420.

In operation S410, the game-providing apparatus may obtain first situation information about a situation faced by the user in the game service.

According to an embodiment, the game-providing apparatus may obtain the first situation information, based on progress and record of the game. For example, in a case of the soccer sports game, the game-providing apparatus may provide the game service about a soccer team operable by the user. A first player belonging to the soccer team may not have recorded an offensive point during last three games. The first situation information may include information indicating that the first player has lost confidence and there is a high possibility that the first player may perform poorly due to a reduced condition when playing a soccer game.

In operation S420, the game-providing apparatus may obtain the first content, based on the prerequisite information and the first situation information.

According to an embodiment, the first content may be content obtained considering the prerequisite information. Descriptions thereof have been described with reference to operation S320 of FIG. 3, and thus redundant description is omitted.

According to an embodiment, the first content may be content obtained considering the first situation information. For example, the first situation information may include information indicating that the first player has lost confidence and there is a high possibility that the first player may perform poorly due to the reduced condition when playing the soccer game. The game-providing apparatus may obtain, as the first content from a coach, a message requesting to exclude the first player from a next game, considering the first situation information.

In addition, the game-providing apparatus may obtain, as the first answer, a message agreeing with the coach's opinion, based in the first content, and provide the game service corresponding to the coach's opinion, based on the obtained first answer. In other words, the game-providing apparatus may provide the game service such that the next game is played without the first player.

As another example, for the same first situation information, the game-providing apparatus may obtain, as the first content, video of the first player being depressed due to the lost confidence, considering the first situation information.

In addition, the game-providing apparatus may obtain, as the first answer, a message encouraging the first player, based in the first content, and provide the game service corresponding to the encouraging message, based on the obtained first answer. For example, the game-providing apparatus may provide the game service such that the first player plays the next game with the improved condition, according to the encouraging message. For example, influence of the first player may be increased in the next game.

According to an embodiment, the game-providing apparatus may obtain the first content by inputting the prerequisite information and the first situation information to an artificial intelligence model. For example, the artificial intelligence model may be a model that performs learning based on massive text data to output data, for example, answer to a question or provide information through conversation with the user. The game-providing apparatus may input text data corresponding to the prerequisite information and the first situation information to the artificial intelligence model, and obtain, as an output, the first content based on the prerequisite information and the first situation information.

Such a method by which the artificial intelligence model learns to obtain the first content is only an example, and the disclosure is not limited thereto.

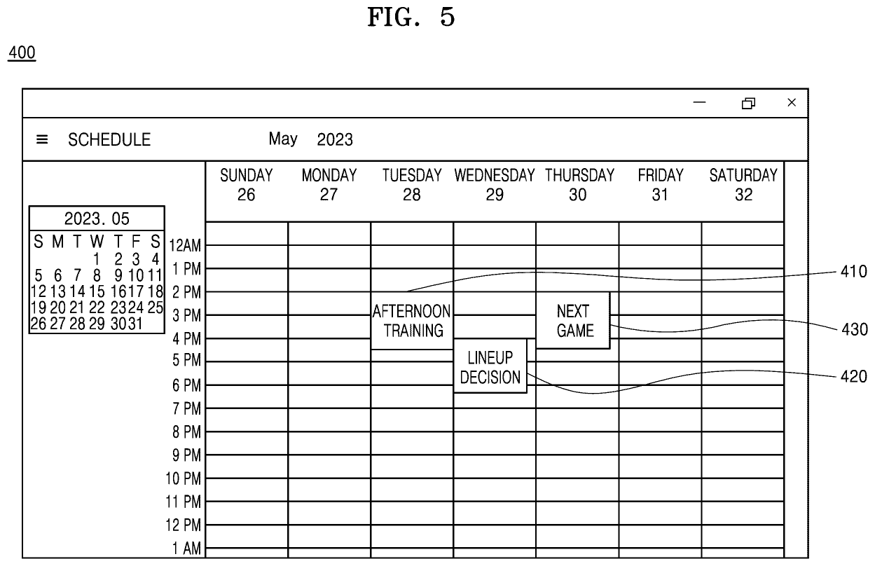

FIG. 5 is a diagram for describing prerequisite information pre-defined for playing a game, according to an embodiment.

According to an embodiment, the game-providing apparatus may obtain prerequisite information pre-defined for playing a game. The game-providing apparatus may store the prerequisite information through a memory or a separate server. The game-providing apparatus may obtain the pre-defined prerequisite information from the memory or the separate server.

In the disclosure, the prerequisite information may include pieces of information that are to be pre-set to proceed with a game service provided by the game-providing apparatus according to an embodiment. For example, when the game service of a soccer sports genre is provided, the prerequisite information may include information about a game schedule of a soccer tournament for proceeding with the game service, information about a team participating in the soccer tournament, and personal information about players belonging to the team.

FIG. 5 illustrates, for example, when the game service of the soccer sports genre is provided, a screen in which the information about the game schedule of the soccer tournament for proceeding with the game service is displayed through a user interface, as the prerequisite information.

Referring to FIG. 5, according to an embodiment, the game-providing apparatus provides a schedule interface 400. The schedule interface 400 may be a user interface displaying a schedule for proceeding with the game service. For example, when a soccer game service is provided, the schedule interface 400 may be a user interface displaying a schedule, such as a soccer game, a training schedule, or a pre-game strategy check schedule, for proceeding with the soccer game service.

According to an embodiment, the schedule interface 400 may be a screen provided through an external service. For example, the game-providing apparatus may access the external service providing a calendar service to display schedules 410 to 430 according to the prerequisite information, through the external service. The user may check the schedules 410 to 430 displayed through the external service.

According to an embodiment, the game-providing apparatus may provide pieces of content related to the schedules 410 to 430 displayed through the external service. The game-providing apparatus may, for example, obtain user inputs of selecting links corresponding to the displayed schedules 410 to 430 and provide content corresponding to the displayed schedules 410 to 430, based on the obtained user inputs.

For example, the game-providing apparatus may obtain the user input of selecting the displayed schedule 410. A method of selecting the displayed schedule 410 may be, for example, a method of simply clicking the displayed schedule 410, but the disclosure is not limited thereto.

The game-providing apparatus may provide the content related to the displayed schedule 410, based on the user input of selecting the displayed schedule 410. For example, the game-providing apparatus may provide one of various pieces of content, such as video, an image, text, an article, a messenger, and the like, related to the displayed schedule 410.

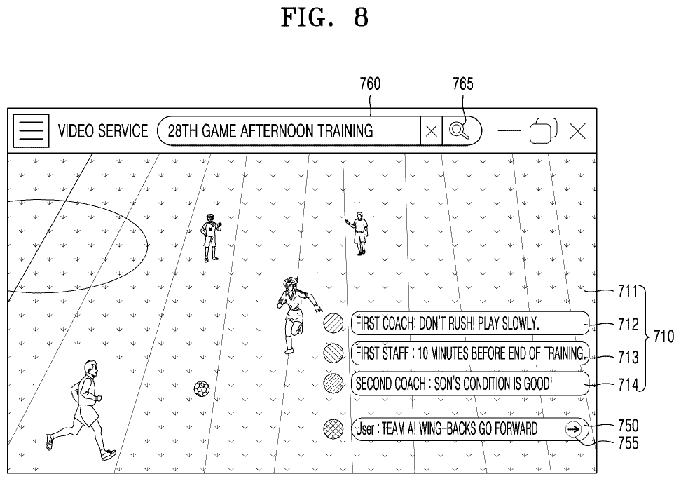

According to an embodiment, referring to FIGS. 5 and 8 together, the game-providing apparatus may obtain the user input of selecting the displayed schedule 410. The game-providing apparatus may provide afternoon training video content shown in FIG. 8, based on the obtained user input.

According to an embodiment, the game-providing apparatus may provide, as first content, a schedule notification of the schedules 410 to 430 according to the prerequisite information. The game-providing apparatus may provide the schedule notification before the schedules 410 to 430 according to the prerequisite information start, by using the external service capable of schedule notification.

The used external service may be the calendar service described with reference to FIG. 5 or a separate external service with a notification function. For example, the external service may be an external service that manages a schedule and provides a notification function before the schedule starts, or an external messenger service that simply provides a text notification function by receiving schedule information before a schedule starts.

According to an embodiment, although not illustrated in FIG. 5, the schedule interface 400 may display personal schedules input by the user through the external service. The displayed personal schedules may be irrelevant to the game service. Information related to the game service providable by the game-providing apparatus and information irrelevant to the game service are provided together through the external service providing the calendar service, thereby improving immersion in the game. The game-providing apparatus provides the game service such that a boundary between the game and reality is blurred, thereby improving immersion of the user in the game.

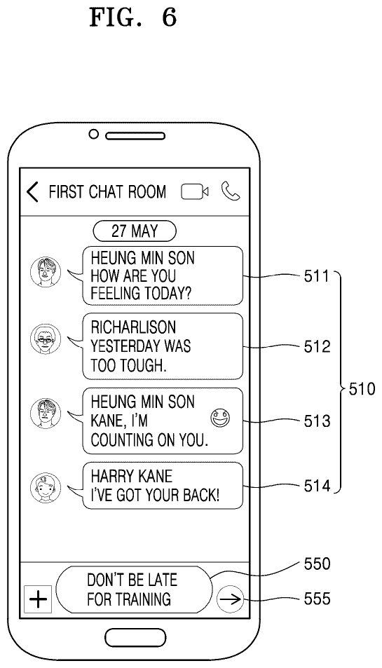

FIG. 6 is a diagram illustrating a user interface for describing an operation of displaying content through an external service, according to an embodiment.

According to an embodiment, the game-providing apparatus may request an external server to display first content 510 through the external service. As shown in FIG. 6, the external service may be a messenger service, but such a type of the external service is only an example and the disclosure is not limited thereto. The first content 510 may be messages displayed through the messenger service, but such a type of the first content 510 is also only an example and the disclosure is not limited thereto.

According to an embodiment, the first content 510 may be displayed through the external service. According to an embodiment, a plurality of pieces of first content 511 to 514 may be displayed.

The game-providing apparatus may access the external service to display the first content 510 in the external service. For example, a user may access the messenger service through a user terminal. The user may check the messages displayed through the messenger service. In this case, the user terminal, as the game-providing apparatus, may access the messenger service to display the messages as the first content 510 in the messenger service.

The first content 510 may be content produced by setting a specific person as a recipient. For example, the first content 510 may be content produced by setting a person holding a position as a soccer coach as the recipient. When such first content 510 is transmitted to the user through the messenger service, the user may receive a virtual experience as if the user is a soccer coach.

A sender of the first content 510 may be a virtual character. The first content 510 may be content transmitted from a fictional character rather than a real person.

For example, as shown in FIG. 6, the game-providing apparatus may display the messenger service on a display, as the external service. The game-providing apparatus may display the messages as the first content 510, through the messenger service. In other words, the game-providing apparatus may provide, through the messenger service, a chat room service in which the user and virtual characters interact with each other. The game-providing apparatus may display a situation where Heung Min Son, Richarlison, and Harry Kane are talking in a first chat room. The first content 510 may include a message received from Heung Min Son, a message received from Richarlison, and a message received from Harry Kane, and Heung Min Son, Richarlison, and Harry Kane may all be virtual characters.

In other words, the game-providing apparatus may display a chat room of Tottenham Hotspur FC that is one of English Premier League professional soccer clubs. The game-providing apparatus may display, as the first content 510, the messages of Heung Min Son, Harry Kane, and Richarlison, who are players in Tottenham Hotspur FC. However, the displayed first content 510 may be the message received from Heung Min Son, but may be a message obtained by an artificial intelligence model rather than actually received from Heung Min Son.

According to an embodiment, the first content 510 may be obtained by the artificial intelligence model. The first content 510 may not be a message transmitted from a real person, but may be a message generated by the artificial intelligence model. Thus, Heung Min Son, Richarlison, and Harry Kane may be virtual character who do not exist. However, Heung Min Son, Richarlison, and Harry Kane are names of real people, and thus, the game-providing apparatus may provide a user experience as if a message is received from a real person.

The artificial intelligence model may be an interactive artificial intelligence model. The artificial intelligence model may be a model that performs learning based on massive text data to output data, for example, answer to a question or provide information through conversation with the user. The game-providing apparatus may obtain the messages as the first content 510 by using the artificial intelligence model.

The game-providing apparatus provides an experience of participating in a chat room of a soccer team, thereby providing, to the user, a game service with improved immersion. Also, the game-providing apparatus allows the user to participate in the chat room from a perspective of a soccer coach, thereby providing, to the user, a virtual experience as if the user is the soccer coach.

According to an embodiment, the game-providing apparatus may obtain a user input through an input interface 550. The input interface 550 may be an interface for obtaining a user input as an answer of the user in the external service.

According to an embodiment, the game-providing apparatus may display the answer of the user through a transmitting interface 555. The transmitting interface 555 may be an interface for transmitting the answer input through the input interface 550 to other users in the chat room.

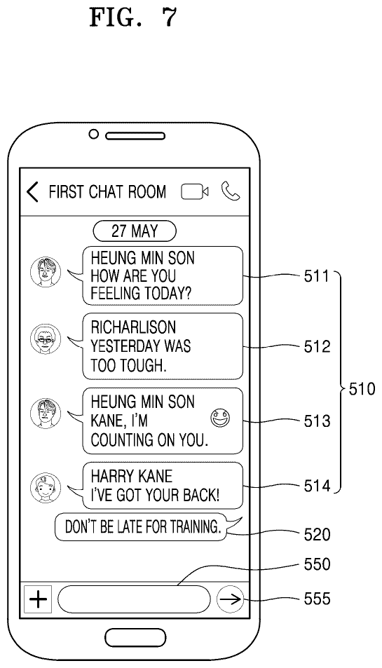

FIG. 7 is a diagram illustrating a user interface for describing an operation of displaying an answer according to displayed content, according to an embodiment.

Referring to FIG. 7, according to an embodiment, the game-providing apparatus may obtain a user input through the input interface 550 and display a user input obtained through the transmitting interface 555 as an answer of a user. The game-providing apparatus may display a first answer 520. In other words, the game-providing apparatus may provide an experience as if the user is participating in a conversation between users in a first chat room.

According to an embodiment, the first answer 520 may be a user input obtained based on the first content 510. The first answer 520 may be obtained based on an input of the user. For example, the first answer 520 may be an answer to one of the plurality of pieces of first content 511 to 514. The first answer 520 may correspond to one of the plurality of pieces of first content 511 to 514.

According to an embodiment, the game-providing apparatus may provide a game service controlled based on the first answer 520. For example, the game-providing apparatus may display, based on the user input, the first answer 520 including content of “don't be late for training”. The game-providing apparatus may proceed with a game so that Heung Min Son, Richarlison, and Harry Kane, who are virtual characters in the game, attend the training on time, based on the first answer 520. The game-providing apparatus may provide the game service such that Heung Min Son, Richarlison, and Harry Kane all benefit from the training.

FIG. 8 is a diagram illustrating a user interface for describing an operation of displaying content through an external service, according to an embodiment.

According to an embodiment, the game-providing apparatus may obtain a search word according to a user input through a search word input interface 760. The search word input interface 760 may be an interface for obtaining a user input to search for first content 711 in an external service.

According to an embodiment, the game-providing apparatus may search for pieces of content related to the search word through a search interface 765. The search interface 765 may be an interface for obtaining a signal to perform a content search operation related to the search word input through the search word input interface 760.

For example, the game-providing apparatus may obtain, through the search word input interface 760, a user input in which “28th game afternoon training” is the search word. The game-providing apparatus may obtain the signal for performing the content search operation related to the “28th game afternoon training” through the search interface 765. The game-providing apparatus may provide the first content 711 including content related to the search word “28th game afternoon training”. Obviously, the game-providing apparatus may obtain a plurality of pieces of content including content related to the search word “28th game afternoon training” and provide the first content 711 according to selection of the user.

The game-providing apparatus may access the external service to display first content 710 in the external service. For example, the user may access a video service through a user terminal. The user may check video or messages provided together, which are displayed through the video service. In this case, the user terminal, as the game-providing apparatus, may access the video service to display the video and the messages as the first content 710 in the video service.

The first content 710 may be content produced by setting a specific person as a recipient. For example, the first content 710 may be content produced by setting a person holding a position as a soccer coach as the recipient.

A sender of the first content 710 may be a virtual character. The first content 710 may be content transmitted from a fictional character rather than a real person.

According to an embodiment, the game-providing apparatus may display the video service as the external service, on a display. The game-providing apparatus may display the video and the messages as the first content 710, through the video service. In other words, the game-providing apparatus may provide a video system and a chatting system for chatting with virtual characters about video, through the video service.

For example, as shown in FIG. 8, the game-providing apparatus may display, as the first content 711, a training video of Tottenham Hotspur FC from among English Premier League professional soccer clubs, through the video service. Also, the game-providing apparatus may display, as pieces of first content 712 to 714, messages according to the training video, together with the training video. The first content 712 to 714 displayed as the messages are displayed as messages from a first coach, a first staff, and a second coach, but may be messages from virtual characters generated by an artificial intelligence model.

The game-providing apparatus provides an experience of receiving the training video of the soccer team and exchanging messages for feedback on the training video, thereby providing, to the user, a game service with improved immersion. Also, the game-providing apparatus provides the training video to the user from a perspective of a soccer coach, thereby providing, to the user, a virtual experience as if the user is the soccer coach.

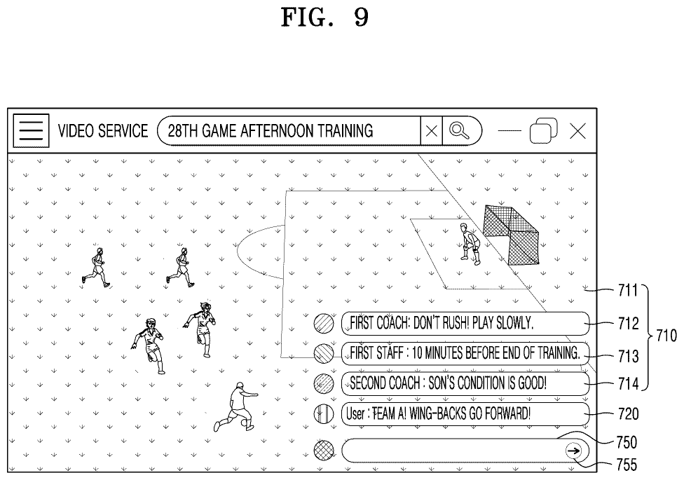

FIG. 9 is a diagram illustrating a user interface for describing an operation of displaying an answer according to displayed content, according to an embodiment.

Referring to FIG. 9, according to an embodiment, the game-providing apparatus may obtain a user input through an input interface 750 and display a user input obtained through a transmitting interface 755 as an answer of a user. In other words, the game-providing apparatus may provide an experience as if the user checks a training video and directly coaches players according to the training video.

According to an embodiment, a first answer 720 may be a user input obtained based on the first content 710. The first answer 720 may be obtained based on an input of the user. For example, the first answer 720 may be an answer to one of a plurality of pieces of first content 711 to 714.

According to an embodiment, the game-providing apparatus may provide a game service controlled based on the first answer 720. For example, the game-providing apparatus may display, based on the user input, the first answer 720 including content of “Team A! Wing-backs go forward!”. The game-providing apparatus may proceed with a game so that players playing wing-back roles of Team A, who are virtual characters in the game, to go forward and play, based on the first answer 720. The game-providing apparatus may control the game so that the user's intention is reflected based on the first answer 720.

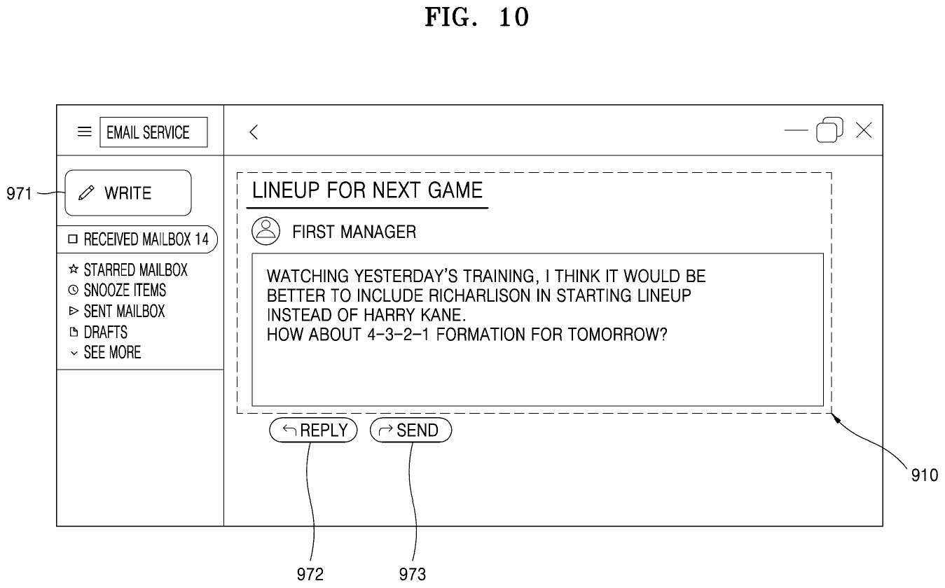

FIG. 10 is a diagram illustrating a user interface for describing an operation of displaying content through an external service, according to an embodiment.

The game-providing apparatus may access the external service to display first content 910 in the external service. For example, a user may access an email service through a user terminal. The user may check emails displayed through the email service. In this case, the user terminal, as the game-providing apparatus, may access the email service to display the emails as the first content 910 in the email service. The game-providing apparatus may display, as the first content 910, an email selected through a user input.

The game-providing apparatus may display, as the first content 910, a title of an email transmitted to the user. For example, as shown in FIG. 10, the title of the email provided as the first content 910 may be “lineup for next game”. In other words, the title suggesting that the transmitted email is about selecting players for a soccer game may be displayed.

The game-providing apparatus may display, as the first content 910, a sender of the email transmitted to the user.

The game-providing apparatus may display content of the first content 910. For example, as shown in FIG. 10, the game-providing apparatus may display, as the first content 910, an email proposing to select Richarlison instead of Harry Kane.

The first content 910 may be content produced by setting a specific person as a recipient. For example, the first content 910 may be content produced by setting a person holding a position as a soccer coach as the recipient. When such first content 910 is transmitted to the user through the email service, the user may receive a virtual experience as if the user is a soccer coach.

the sender of the first content 910 may be a virtual character. The first content 910 may be content transmitted from a fictional character rather than a real person. According to an embodiment, the first content 910 may be obtained by an artificial intelligence model. The first content 910 may not be an email transmitted from a real person, but may be an email generated by the artificial intelligence model. Accordingly, a first manager who is the sender of the first content 910 may be a virtual character who does not exist.

The game-providing apparatus provides an experience of receiving an email from a staff of a soccer team, thereby providing, to the user, a game service with improved immersion. Also, the game-providing apparatus allows the user to receive an email from a perspective of a soccer coach, thereby providing, to the user, a virtual experience as if the user is the soccer coach.

According to an embodiment, the game-providing apparatus may display a webpage for writing an email through an email writing interface 971. For example, the game-providing apparatus may display the email as the first content 910 and display the webpage for writing a new email through the external service by obtaining a user input of clicking the email writing interface 971.

Also, the game-providing apparatus may display a webpage for replying to the email through an email replying interface 972. The game-providing apparatus may display a webpage for transmitting an email through an email transmitting interface 973.

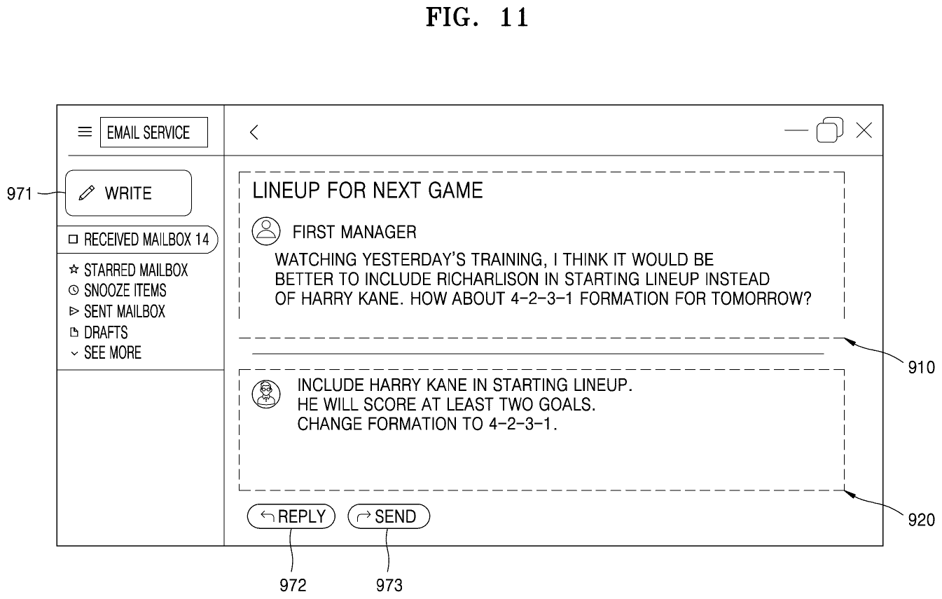

FIG. 11 is a diagram illustrating a user interface for describing an operation of displaying an answer according to displayed content, according to an embodiment.

For reference, FIG. 11 illustrates a display displaying an email received as the first content 910 and a first answer 920 as a reply to the received email.

Referring to FIG. 11, according to an embodiment, the first answer 920 may be a user input obtained based on the first content 910. The first answer 920 may be obtained based on an input of a user. For example, the first answer 920 may be an answer to the first content 910.

Although not illustrated in FIG. 11, the game-providing apparatus may obtain a user input to reply to the first content 910 through the email replying interface 972 and receive content of an email to be replied. The game-providing apparatus may display the first answer 920 according to the input content of the email.

According to an embodiment, the game-providing apparatus may provide a game service controlled based on the first answer 920. For example, based on the user input, the game-providing apparatus may display the first answer 920 indicating to include Harry Kane in a starting lineup and change a formation to 4-2-3-1. The game-providing apparatus may proceed with the game so that a next game is played by including Harry Kane, who is a virtual character in a game, in the starting lineup and changing the formation to 4-2-3-1, based on the first answer 920.

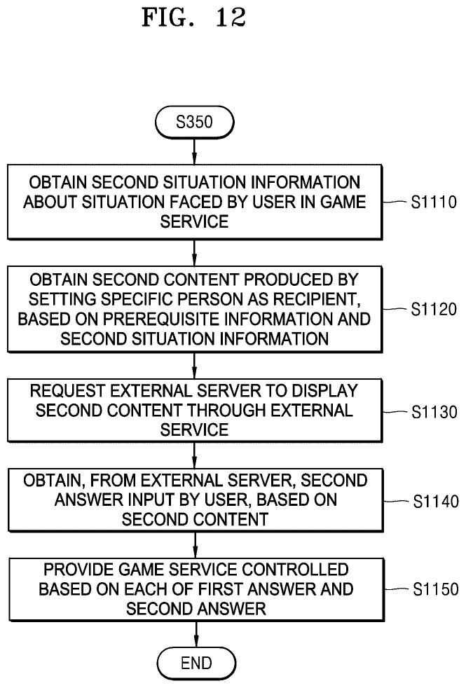

FIG. 12 is a flowchart of a method of providing a game service, according to an embodiment.

For convenience of description, details that overlap those described with reference to FIGS. 3 and 4 will be briefly described or omitted.

Referring to FIG. 12, operation S1110 may be performed after operation S350 of FIG. 3.

In operation S1110, the game-providing apparatus may obtain second situation information about a situation faced by the user in the game service.

According to an embodiment, the game-providing apparatus may obtain the second situation information, based on the progress and record of the game. For example, in a case of the soccer sports game, the game-providing apparatus may provide the game service about a soccer team operable by the user. A first player belonging to the soccer team may not have recorded an offensive point during last three games. The second situation information may include information indicating that the first player has lost confidence and there is a high possibility that the first player may perform poorly due to a reduced condition when playing a soccer game.

In the disclosure, the second situation information may be a same type of information as the first situation information but may be distinguished from the first situation information with respect to an obtained time. For example, the first situation information is information obtained before the game service is controlled based on the first answer according to operation S350, and the second situation information is information obtained after the game service is controlled according to operation S350.

In operation S1120, the game-providing apparatus may obtain second content produced by setting the specific person as the recipient, based on the prerequisite information and the second situation information.

According to an embodiment, the second content may be content obtained considering the prerequisite information. Descriptions thereof have been described with reference to operation S320 of FIG. 3, and thus redundant description is omitted.

According to an embodiment, the second content may be content obtained considering the second situation information.

For example, the second situation information may include information indicating that the first player has lost confidence and there is a high possibility that the first player may perform poorly due to the reduced condition when playing the soccer game. The game-providing apparatus may obtain, as the second content from the coach, a message requesting to exclude the first player from the next game, considering the second situation information.

According to an embodiment, the game-providing apparatus may obtain the second content by inputting the second situation information to the artificial intelligence model. For example, the artificial intelligence model may be a model that performs learning based on massive text data to output data, for example, answer to a question or provide information through conversation with the user. The game-providing apparatus may input text data corresponding to the second situation information to the artificial intelligence model, and obtain, as an output, the second content based on the second situation information.

Such a method by which the artificial intelligence model learns to obtain the second content is only an example, and the disclosure is not limited thereto.

In operation S1130, the game-providing apparatus may request the external server to display second content through the external service. Descriptions about operation S1130 overlap those about operation S330 of FIG. 3, and thus operation S1130 will be briefly described.

The game-providing apparatus may request the external server to display the second content through the user terminal. Based on the request, the second content may be displayed through the user terminal.

In operation S1140, the game-providing apparatus may obtain, from the external server, a second answer input by the user, based on the second content.

According to an embodiment, the second answer may include at least one of text and speech.

According to an embodiment, the second answer may be a user input that is input through an interface of the user terminal. The game-providing apparatus may obtain the second answer from the user terminal, and obviously, some or all of operations of the user terminal may be included in operations of the game-providing apparatus.

According to an embodiment, the second answer may be stored and displayed through the external service. The game-providing apparatus may request the external server to transmit the second answer and obtain the second answer from the external server.

In operation S1150, the game-providing apparatus may provide the game service controlled based on each of the first answer and the second answer. Descriptions about operation S1150 overlap those about operation S350 of FIG. 3, and thus operation S1130 will be briefly described.

According to an embodiment, the game-providing apparatus may frequently control the game service, based on a plurality of answers. The game-providing apparatus may provide the game service controlled based on the first answer and then provide the game service controlled based on the second answer. The number of answers does not limit the disclosure. For example, it has been described that the game service is controlled based on each of the first answer and the second answer, but it would be obvious that the game service may be controlled based on a third answer thereafter.

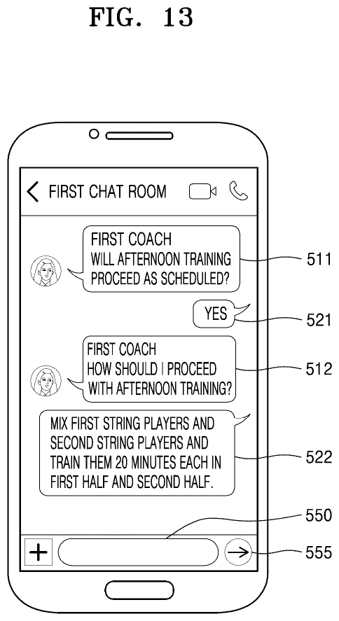

FIG. 13 is a diagram illustrating a user interface for describing an operation of communicating as content and an answer are repeatedly obtained, according to an embodiment.

For convenience of description, details that overlap those described with reference to FIGS. 6 and 7 will be briefly described or omitted.

According to an embodiment, the game-providing apparatus may request the external server to display first content 511 through the external service.

According to an embodiment, the game-providing apparatus may display a first answer 521 as an answer to the first content 511. The first answer 521 may be obtained based on an input of the user.

According to an embodiment, the game-providing apparatus may request the external server to display second content 512 through the external service. Descriptions about the second content 512 overlap those about the first content 511, and thus the second content 512 is briefly described.

According to an embodiment, the second content 512 may be content produced by setting a specific person as a recipient. A sender of the second content 512 may be a virtual character.

According to an embodiment, the second content 512 may be obtained by the artificial intelligence model. The second content 512 may not be a message transmitted from a real person, but may be a message generated by the artificial intelligence model.

According to an embodiment, the game-providing apparatus may display a second answer 522 as an answer to the second content 512. The second answer 522 may be obtained based on an input of the user. Descriptions about the second answer 522 overlap those about the first answer 521, and thus the second answer 522 is briefly described.

The second answer 522 may be a user input that is input by the user, based on the second content 512. The second answer 522 may be a user input that is input through the user terminal.

According to an embodiment, the game-providing apparatus may provide the game service controlled based on the first answer 521. The game-providing apparatus may provide the game service controlled based on the second answer 522. The game-providing apparatus may provide the game service controlled based on each of the first answer 521 and the second answer 522.

For example, as shown in FIG. 13, in response to the first content 511 inquiring whether to proceed with afternoon training as scheduled, the game-providing apparatus may display the first answer 521 indicating affirmation. The game-providing apparatus may proceed with the afternoon training as scheduled, based on the first answer 521.

Also, in response to the second content 512 inquiring a training method, the game-providing apparatus may display the second answer 522 indicating to mix first string players and second string players together and train them 20 minutes each in a first half and a second half. The game-providing apparatus may provide game content of the afternoon training, based on the second answer 522.

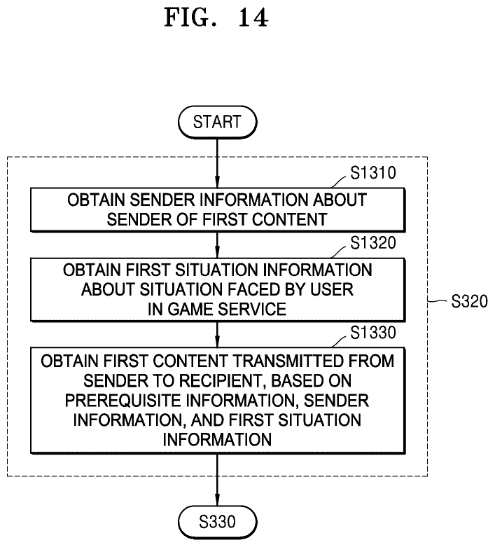

FIG. 14 is a flowchart of a method of providing a game service, according to an embodiment.

According to an embodiment, operation S320 of FIG. 3 may include operations S1310, S1320, and S1330.

In operation S1310, the game-providing apparatus may obtain sender information about the sender of the first content.

According to an embodiment, the first content may be content transmitted from the sender to the recipient. For example, the first content may be a message. The sender information may include information about a sender of the message. As another example, the first content may be an email. The sender information may include information about a sender of the email.

In operation S1320, the game-providing apparatus may obtain the first situation information about the situation faced by the user in the game service. In operation S1330, the game-providing apparatus may obtain the first content transmitted from the sender to the recipient, based on the prerequisite information, the sender information, and the first situation information.

According to an embodiment, the first content may be content obtained considering the prerequisite information. Descriptions thereof have been described with reference to operation S320 of FIG. 3, and thus redundant description is omitted.

Referring to FIGS. 8 and 14 together, for example, the game-providing apparatus may obtain the first content 712. In detail, the game-providing apparatus may obtain sender information indicating that a sender of the first content 712 is a first coach. The game-providing apparatus may obtain, as the situation faced by the user, the first situation information about a situation where soccer team players operated by the user are training. The game-providing apparatus may obtain the first content 712 about comments of the first coach during the training of the players, based on the sender information and the first situation information.

As another example, the game-providing apparatus may obtain the first content 713. In detail, the game-providing apparatus may obtain sender information indicating that a sender of the first content 713 is a first staff. The game-providing apparatus may obtain, as the situation faced by the user, the first situation information about a situation where the soccer team players operated by the user are training. The game-providing apparatus may obtain the first content 713 about comments of the first staff during the training of the players, based on the sender information and the first situation information.

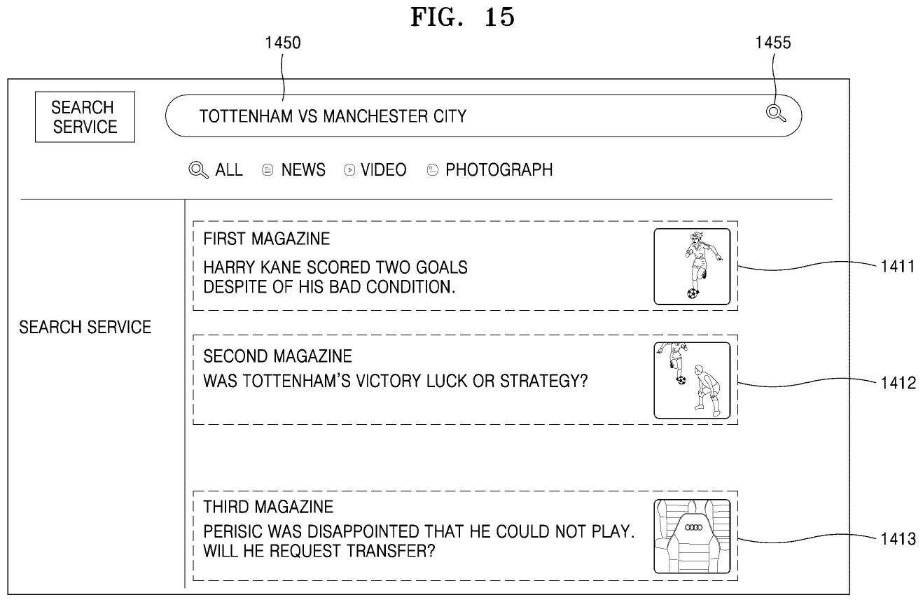

FIG. 15 is a diagram illustrating a user interface for describing an operation of displaying content through the external service, according to some embodiments.

According to an embodiment, the game-providing apparatus may provide pieces of content for determining situation information about a situation faced by the user. The game-providing apparatus may determine the situation information, based on the provided pieces of content. For example, the provided pieces of content may be provided in the form of articles as shown in FIG. 15, but they are only examples and do not limit the disclosure.

As another example, unlike as shown in FIG. 15, the provided pieces of content may be content configured in at least one of video, an image, and text. In detail, the provided content may be video content captured targeting a character expressing a behavior or facial expression of a specific person through a camera or special equipment, video content manufactured targeting a character in the game service, or image content captured simply targeting a character or text content describing the character, aside from video.

Referring to FIG. 15, the user interface displaying a plurality of articles through a web search service is illustrated. According to an embodiment, the game-providing apparatus may display the plurality of articles through the web search service by accessing the web search service. The external service may include the web search service.

According to an embodiment, the game-providing apparatus may obtain a search word according to a user input through a search word input interface 1450. The search word input interface 1450 may be an interface for obtaining a user input to search for pieces of first content 1411 to 1413 in the external service. For example, the search word input interface 1450 may be an interface for obtaining a user input to search for articles in the web search service.

According to an embodiment, the game-providing apparatus may search for pieces of content related to the search word through a search interface 1455. The search interface 1455 may be an interface for obtaining a signal to perform a content search operation related to the search word input through the search word input interface 1450.

According to an embodiment, the game-providing apparatus may display the pieces of first content 1411 to 1413 as results of searching for “Tottenham vs Manchester City” through the search word input interface 1450 and the search interface 1455. For example, the game-providing apparatus may display a plurality of articles as the results of search. However, a type of first content does not limit the disclosure.

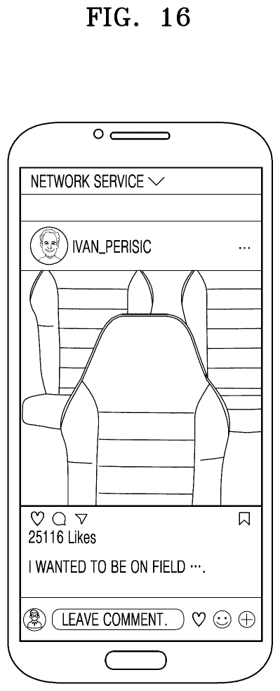

FIG. 16 is a diagram illustrating a user interface for describing an operation of displaying content through the external service, according to some embodiments.

Referring to FIG. 16, according to an embodiment, the game-providing apparatus may request the external server to display the first content, based on the sender information and the first situation information. The game-providing apparatus may display the first content through the external service.

A user interface displaying a post through a network service is illustrated. According to an embodiment, the game-providing apparatus may display a plurality of posts through the network service by accessing the network service. The external service may include the network service. The network service may be SNS. The first content may include a post provided through the network service.

According to an embodiment, a writer of the post as the first content may be a virtual character. The first content may be content prepared by a fictional character rather than a real person. For example, the first content displayed through the network service may be obtained by an artificial intelligence model. The first content may not be a post written by a real person, but may be a post generated by the artificial intelligence model.

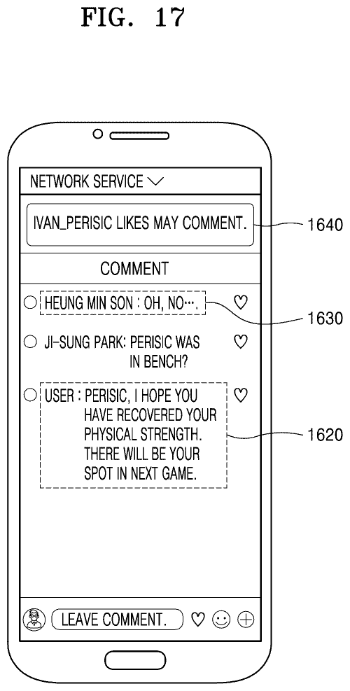

FIG. 17 is a diagram illustrating a user interface for describing an operation of displaying an answer according to displayed content, according to some embodiments.

Referring to FIG. 17, according to an embodiment, the game-providing apparatus may obtain a first answer 1620 input by the user, based on the first content illustrated in FIG. 16, and display the first answer 1620.

For example, as shown in FIG. 17, the game-providing apparatus may display the first answer 1620 according to a user input. The game-providing apparatus may obtain a message encouraging “Ivan_Perisic”, as the first answer 1620. The game-providing apparatus may display the message encouraging “Ivan_Perisic”, as the first answer 1620.

Obviously, the game-providing apparatus may display a reaction 1640 of “Ivan_Perisic” for the first answer 1620, but this is not essential. Also, the game-providing apparatus may obtain a plurality of other answers 1630 in addition to the first answer 1620 of the user, and display the same. The plurality of other answers 1630 may be messages input by other users or messages obtained by an artificial intelligence model with a virtual character as a writer.

For reference, operations of obtaining the first content, based on the sender information and the first situation information, and obtaining the first answer to the first content, according to an embodiment, will be additionally described with reference to FIGS. 15 to 17.

Referring to FIGS. 15 to 17, according to an embodiment, the game-providing apparatus may obtain the first situation information. For example, as shown in FIG. 15, the game-providing apparatus may display the first content 1413 written by a third magazine. The first content 1413 may be an article related to news that “Perisic” who is a soccer team player in the provided game service is unhappy in his team. The first situation information may include information indicating that “Perisic” is unhappy in his team.

According to an embodiment, the game-providing apparatus may obtain the sender information. For example, the game-providing apparatus may obtain the sender information in which “Perisic” is a sender, to obtain the first content.

According to an embodiment, as shown in FIG. 16, the game-providing apparatus may obtain the first content, based on the sender information and the first situation information. In detail, the game-providing apparatus may obtain, as the first content, a post that is based on a situation in which “Perisic” is unhappy and implies that “Perisic” is not happy, with the “Perisic” as a subject.

According to an embodiment, the game-providing apparatus may obtain the first answer, based on the first content, and display the first answer. For example, as shown in FIG. 17, the game-providing apparatus may obtain the first answer 1620 encouraging “Perisic” according to a user input.

The game-providing apparatus may provide the game service controlled based on the first answer 1620. For example, the game-providing apparatus may change a condition, a current mood, and the like of “Perisic” in a next game, based on the first answer 1620 encouraging “Perisic”. Influence of “Perisic” on the next game may change depending on the changed condition, mood, and the like.

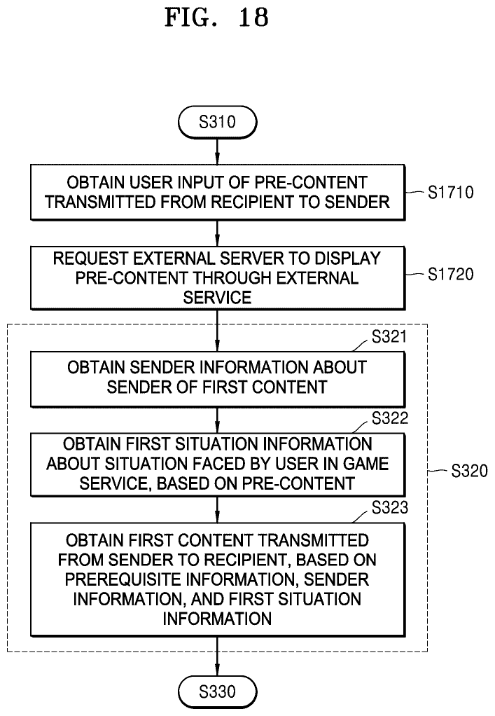

FIG. 18 is a flowchart of a method of providing a game service, according to some embodiments.

For convenience of description, details that overlap those described with reference to FIGS. 3 and 12 will be briefly described or omitted.

Referring to FIG. 18, operation S320 of FIG. 3 may include operations S321, S322, and S323. Also, operations S1710 and S1720 may be performed between operations S310 and S320.

In operation S1710, the game-providing apparatus may obtain a user input of pre-content transmitted from the recipient to the sender.

According to an embodiment, the pre-content may be content obtained according to a user input before the first content is obtained.

The pre-content may include at least one of an image, video, text, and speech. For example, the pre-content may be a message displayed through the messenger service that is the external service. As another example, the pre-content may be an email displayed through the email service that is the external service. As another example, the pre-content may be a post displayed through SNS that is the external service. As another example, the pre-content may be video content transmittable through the messenger service.

According to an embodiment, the pre-content may denote content transmitted from the recipient to the sender, based on the meaning of first content transmitted from the sender to the recipient.

In operation S1720, the game-providing apparatus may request the external server to display the pre-content through the external service.

For example, the game-providing apparatus may request the external server to display, as the pre-content, the message through the messenger service that is the external service. The game-providing apparatus may display the message through the messenger service.

In operation S321, the game-providing apparatus may obtain the sender information about the sender of the first content. Descriptions about operation S321 overlap those about operation S1310 of FIG. 14, and thus are omitted.

In operation S322, the game-providing apparatus may obtain the first situation information about the situation faced by the user in the game service, based on the pre-content. Descriptions about operation S322 partially overlap those about operation S1320 of FIG. 14, and thus, a difference will be mainly described.

According to an embodiment, the game-providing apparatus may obtain the first situation information, based on the pre-content. In other words, the first situation information may be obtained considering the pre-content. For example, the game-providing apparatus may obtain the pre-content including content related to an instruction to urgently proceed with training, according to a user input. The game-providing apparatus may obtain the first situation information indicating that urgent training will be proceeded, based on the obtained pre-content.

In operation S323, the game-providing apparatus may obtain the first content transmitted from the sender to the recipient, based on the prerequisite information, the sender information, and the first situation information. Descriptions about operation S323 overlap those about operation S1330 of FIG. 14, and thus are omitted.

For example, when the first situation information indicating that the urgent training will be proceeded, based on the pre-content, is obtained, the game-providing apparatus may obtain the first content objecting to the urgent training. As another example, the game-providing apparatus may obtain the first content of checking an urgent training schedule.

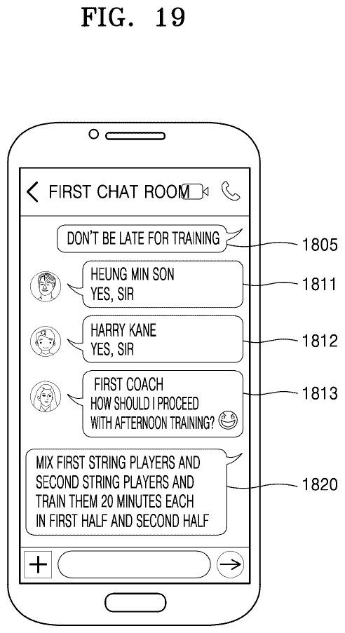

FIG. 19 is a diagram illustrating a user interface for describing an operation of displaying the pre-content before an operation of communicating as content and answers are obtained is performed, according to some embodiments. For convenience of description, details that overlap those described with reference to FIGS. 6, 7, and 18 will be briefly described or omitted.

Referring to FIG. 19, according to an embodiment, the game-providing apparatus may request the external server to display pre-content 1805 through the external service. The pre-content 1805 may be a message displayed through the messenger service, but such a type of the pre-content 1805 is also only an example and the disclosure is not limited thereto.

A recipient of the pre-content 1805 may be a virtual character. The pre-content 1805 may be content intended to be transmitted to a fictional character rather than a real person.

For example, as shown in FIG. 19, the game-providing apparatus may display the messenger service on the display, as the external service. The game-providing apparatus may display the message as the pre-content 1805, through the messenger service. In other words, the game-providing apparatus may provide, through the messenger service, a chat room service in which the user and virtual characters interact with each other.

According to an embodiment, the game-providing apparatus may obtain a user input as the pre-content 1805. The game-providing apparatus may display the pre-content 1805 through the external service. For example, as shown in FIG. 19, the game-providing apparatus may display the message as the pre-content 1805 through the messenger service.

According to an embodiment, the game-providing apparatus may obtain pieces of first content 1811 to 1813, based on the pre-content 1805. The game-providing apparatus may obtain the pieces of first content 1811 to 1813 considering the pre-content 1805. The game-providing apparatus may display the pieces of first content 1811 to 1813 through the external service.

For example, the game-providing apparatus may display the pre-content 1805 requesting not to be late for training. The game-providing apparatus may obtain the pieces of first content 1811 and 1812 answering to the displayed pre-content 1805. Also, the game-providing apparatus may obtain the first content 1813 inquiring how to proceed with the training, based on the displayed pre-content 1805. The game-providing apparatus may display the pieces of first content 1811 to 1813 through the messenger service.

According to an embodiment, the game-providing apparatus may obtain a first answer 1820, based on the pieces of first content 1811 to 1813. The game-providing apparatus may provide the game service controlled based on the first answer 1820.

According to an embodiment, the pre-content 1805 may be used as content for recruiting a player outside a team operated by the user in the game service.

For example, the game-providing apparatus may obtain pre-content with a player belonging another team as a recipient. Content of the obtained pre-content may be configured according to a user input. The game-providing apparatus may obtain the pre-content proposing a specific player to transfer to the team operated by the user in the game service, and control the game service by transmitting the pre-content to the specific player for an interaction.

The game-providing apparatus may obtain first content as an answer based on the pre-content. The game-providing apparatus may obtain the first content considering the pre-content.

For example, the game-providing apparatus may obtain the first content including the meaning of acceptance, as the answer to the pre-content proposing recruitment. In this case, the game-providing apparatus may control the game service such that a game is played after the specific player transfers to the team operated by the user in the game service.

For example, the game-providing apparatus may obtain the first content including the meaning of rejection, as the answer to the pre-content proposing recruitment. In this case, the game-providing apparatus may control the game service such that the specific player does not transfer to the team operated by the user in the game service.

Obviously, the pre-content is content first generated by the user to interact with a character in the game, and a recipient of the pre-content may vary, such as a player, a coach, a staff, a reporter, or an ordinary person, and the disclosure is not limited thereto.

According to an embodiment, the pre-content may be content related to goods. According to an embodiment, the pre-content may be content related to game goods for playing the game in the game service. According to an embodiment, the pre-content may be content related to real goods.

For example, the game-providing apparatus may obtain the game goods or real goods as the pre-content, and deliver the game goods or real goods with the specific player as the recipient.

For example, the game-providing apparatus may request the external server to display the pre-content through the external service. The displayed pre-content is the game goods or real goods, and may be content provided by the sender to the recipient of the pre-content as a gift.

In detail, the game-providing apparatus may obtain a user input for providing a first gift from the user to the recipient, as the pre-content. The first gift may include goods in the game, items in the game (e.g., objects such as costumes, weapons, and soccer balls), real goods, real articles, or a service for delivering the same, and denotes goods or objects capable of being delivered with the meaning of gift. Thus, a type of the first gift does not limit the disclosure. In addition, according to an embodiment, the game-providing apparatus may obtain a user input for providing, as the first gift, some of transfer fees to recruit a specific player in a soccer game service, and display and provide the pre-content according to the obtained user input.

The game-providing apparatus may obtain the user input for providing the first gift through the external server. For example, the game-providing apparatus may obtain the user input for providing the first gift with the specific player in the game service as the recipient, through the external service. A method of providing the first gift does not limit the disclosure, and may include, first gift delivery through a gift function in the messenger service, delivery of the goods through a cash transaction service, or the like.

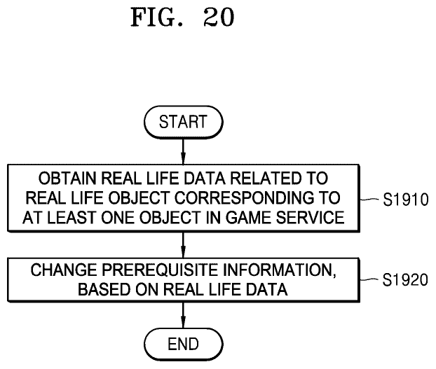

FIG. 20 is a flowchart of a method of providing a game service, according to an embodiment.

For convenience of description, details that overlap those described with reference to FIG. 3 will be briefly described or omitted.

Referring to FIG. 20, in operation S1910, the game-providing apparatus may obtain real life data related to a real life object corresponding to at least one object in the game service.

According to an embodiment, the object may denote a virtual object existing in a game space. For example, the object may include a character (e.g., an avatar, a player belonging to a soccer team operated by the user, or the like) of the user, but is not limited thereto, and may denote any object implemented in the game space, such as a background, a terrain, or the like.

For example, the at least one object may include a virtual soccer player character existing in the game space, based on soccer player Messi. The game-providing apparatus may obtain, based on virtual Messi, real life data related to Messi in real life. For example, the real life data may include pieces of information related to Messi in real life, such as information about the height of Messi, information about the weight of Messi, and information about Messi being transferred to Inter Miami FC in 2023.

According to an embodiment, the game-providing apparatus may obtain pre-stored real life data from a memory. Alternatively, the game-providing apparatus may obtain real life data from the external server. For example, the game-providing apparatus may obtain the real life data, based on Internet articles displayed through a web search service.

In operation S1920, the game-providing apparatus may change the prerequisite information, based on the real life data.

For example, the game-providing apparatus may obtain the real life data indicating that Messi has transferred to Inter Miami FC in 2023. The game-providing apparatus may change the prerequisite information, based on the obtained real life data. The prerequisite information may include setting information about a team of a character in the game service. The game-providing apparatus may change a team of virtual Messi in the game service, based on the real life data.

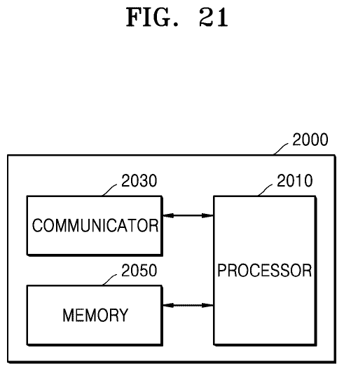

FIG. 21 is a diagram for describing a specific configuration of a game-providing apparatus 2000, according to some embodiments.

As shown in FIG. 21, the game-providing apparatus 2000 according to some embodiments may include at least one processor 2010, a communicator 2030, and a memory 2050. However, the components shown in FIG. 21 are not all essential components of the game-providing apparatus 2000. The game-providing apparatus 2000 may include more or fewer components than those shown in FIG. 21. The game-providing apparatus 2000 may be a user terminal, a server, a game network system, or a separate device.

According to an embodiment, the processor 2010 may generally control all operations of the game-providing apparatus 2000. For example, the processor 2010 may execute a program stored in the memory 2050 to control the communicator 2030 and the memory 2050 in general. The processor 2010 may control operations of the game-providing apparatus 2000 of the present specification by controlling the communicator 2030 and the memory 2050.

According to an embodiment, the processor 2010 may obtain prerequisite information pre-defined for playing a game. The processor 2010 may obtain first content produced by setting a specific person as a recipient, based on the prerequisite information, and request an external server configured to provide an external service, to display the first content through the external service. The processor 2010 may obtain a first answer input by a user, based on the first content, and provide a game service controlled based on the first answer.

According to an embodiment, the processor 2010 may obtain first situation information about a situation faced by the user in the game service and obtain the first content, based on the prerequisite information and the first situation information.

According to an embodiment, the processor 2010 may obtain second situation information about a situation faced by the user in the game service, obtain second content produced by setting the specific person as the recipient, based on the prerequisite information and the second situation information, request the external server to display the second content through the external service, obtain, from the external server, a second answer input by the user, based on the second content, and provide the game service controlled based on each of the first answer and the second answer.

According to an embodiment, the processor 2010 may obtain sender information about a sender of the first content, obtain the first situation information about the situation faced by the user in the game service, and obtain the first content transmitted from the sender to the recipient, based on the prerequisite information, the sender information, and the first situation information.

According to an embodiment, the processor 2010 may obtain a user input of pre-content transmitted from the recipient to the sender and request the external server to display the pre-content through the external service.

According to an embodiment, the processor 2010 may receive, from the external server, the first answer obtained in the external service.

According to an embodiment, the processor 2010 may obtain real life data related to a real life person corresponding to at least one character in the game service, and change the prerequisite information, based on the real life data.

According to an embodiment, the communicator 2030 may perform communication with an external device under control by the processor 2010. For example, the communicator 2030 may perform communication with the external device, such as a payment server or an authentication server, under control by the processor 2010. Also, the communicator 2030 may obtain user information or a user input through communication with an external interface.

According to an embodiment, the processor 2010 may perform communication with the external server through the communicator 2030, and display or obtain data through the external service. According to an embodiment, the processor 2010 may communicate by using the communicator 2030 to display the first content or obtain the first answer through the external server.

The memory 2050 may store programs for processes and controls by the processor 2010 and may store data input to or output from the game-providing apparatus 2000.

According to an embodiment, the processor 2010 may execute a method of providing a game service by using the program stored in the memory 2050.

According to an embodiment, the memory 2050 may include at least one type of storage medium among a flash memory type, a hard disk type, a multimedia card micro type, a card type memory (for example, a secure digital (SD) or an extreme digital (XD) memory), a random-access memory (RAM), a static RAM (SRAM), a read-only memory (ROM), an electrically erasable programmable ROM (EEPROM), a programmable ROM (PROM), a magnetic memory, a magnetic disk, and an optical disk. Also, according to an embodiment, the programs stored in the memory 2050 may be classified into a plurality of modules according to functions.

According to an embodiment, the method of providing a game service may be performed by the game-providing apparatus 2000, a server, or a user terminal, and at least one component included in the game-providing apparatus 2000 may perform embodiments described above with reference to FIGS. 1 to 20.

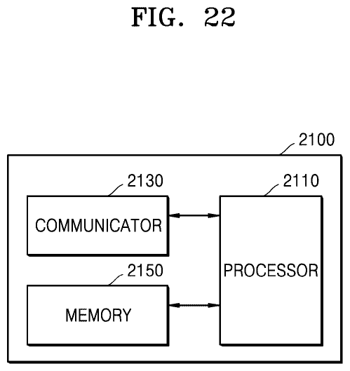

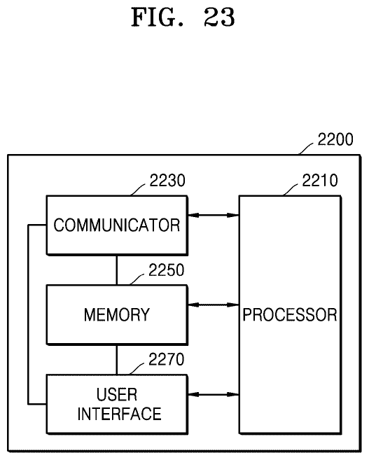

The method of providing a game service may be performed by the server and the user terminal individually or together. Configurations of the server and the user terminal will be described in further detail below with reference to FIGS. 22 and 23.

FIG. 22 is a diagram for describing a specific configuration of a server 2100, according to some embodiments.

As shown in FIG. 22, the server 2100 according to some embodiments may include at least one processor 2110, a communicator 2130, and a memory 2150. However, the components shown in FIG. 22 are not all essential components of the server 2100. The server 2100 may include more or fewer components than those shown in FIG. 22.

According to an embodiment, the processor 2110 may generally control all operations of the server 2100. For example, the processor 2110 may execute a program stored in the memory 2150 to control the communicator 2130 and the memory 2150 in general. The processor 2110 may control operations of the server 2100 of the present specification by controlling the communicator 2130 and the memory 2150.

According to an embodiment, the processor 2110 may obtain prerequisite information pre-defined for playing a game. The processor 2110 may obtain first content produced by setting a specific person as a recipient, based on the prerequisite information, and request an external server configured to provide an external service, to display the first content through the external service. The processor 2110 may obtain a first answer input by a user, based on the first content, and provide a game service controlled based on the first answer.

According to an embodiment, operations of the processor 2110 may correspond to operations of the processor 2010 of the game-providing apparatus 2000, described with reference to FIG. 21, and thus detailed descriptions thereof are omitted.

The communicator 2130 may provide an inquiry to a user terminal 2200 under control by the processor 2110 and receive response information to the inquiry. Also, according to an embodiment, the communicator 2130 may transmit or receive data to or from the user terminal 2200, and the data transmitted or received to or from the user terminal 2200 may include control data for controlling the user terminal 2200 or a program included in the user terminal 2200.

The memory 2150 may store programs for processes and controls by the processor 2110 and may store data input to or output from the server 2100.

According to an embodiment, the processor 2110 may execute a method of providing a game service by using the program stored in the memory 2150.

According to an embodiment, the memory 2150 may include at least one type of storage medium among a flash memory type, a hard disk type, a multimedia card micro type, a card type memory (for example, a secure digital (SD) or an extreme digital (XD) memory), a random-access memory (RAM), a static RAM (SRAM), a read-only memory (ROM), an electrically erasable programmable ROM (EEPROM), a programmable ROM (PROM), a magnetic memory, a magnetic disk, and an optical disk. Also, according to an embodiment, the programs stored in the memory 2150 may be classified into a plurality of modules according to functions.

According to an embodiment, the method of providing a game service may be performed dividedly by the server 2100 and the user terminal 2200, performed individually by the server 2100 and the user terminal 2200, or performed by the game-providing apparatus 2000.

FIG. 23 is a diagram for describing a specific configuration of the user terminal 2200, according to some embodiments.

As shown in FIG. 23, the user terminal 2200 according to some embodiments may include at least one processor 2210, a communicator 2230, a memory 2250, and a user interface 2270. However, the components shown in FIG. 23 are not all essential components of the user terminal 2200. The user terminal 2200 may include more or fewer components than those shown in FIG. 23.

According to an embodiment, the processor 2210 may generally control all operations of the user terminal 2200. For example, the processor 2210 may execute a program stored in the memory 2250 to control the communicator 2230, the memory 2250, and the user interface 2270 in general. The processor 2210 may control operations of the user terminal 2200 of the present specification by controlling the communicator 2230, the memory 2250, and the user interface 2270.

According to an embodiment, the processor 2210 may obtain prerequisite information pre-defined for playing a game. The processor 2210 may obtain first content produced by setting a specific person as a recipient, based on the prerequisite information, and request an external server configured to provide an external service, to display the first content through the external service. The processor 2210 may obtain a first answer input by a user, based on the first content, and provide a game service controlled based on the first answer.

According to an embodiment, operations of the processor 2210 may correspond to operations of the processor 2010 of the game-providing apparatus 2000, described with reference to FIG. 21, and thus detailed descriptions thereof are omitted.

The communicator 2230 may provide an inquiry to the server 2100 under control by the processor 2210 and receive response information to the inquiry. Also, according to an embodiment, the communicator 2230 may transmit or receive data to or from the server 2100, and the data transmitted or received to or from the server 2100 may include control data for controlling the user terminal 2200 or a program included in the user terminal 2200.

According to an embodiment, the communicator 2230 may include a Bluetooth communicator, a Bluetooth low energy (BLE) communicator, a near field communicator, a wireless local area network (WLAN) (Wi-Fi) communicator, a ZigBee communicator, an infrared data association (IrDA) communicator, a Wi-Fi direct (WFD) communicator, an ultra-wideband (UWB) communicator, or an Ant+ communicator, but is not limited thereto.

According to an embodiment, the communicator 2230 transmits or receives a wireless signal to or from at least one of a base station, an external terminal, and a server, on a mobile communication network. Here, the wireless signal may include various types of data according to exchange of a voice call signal, an image call signal, or a text/multimedia message.

The memory 2250 may store programs for processes and controls by the processor 2210 and may store data input to or output from the user terminal 2200. According to an embodiment, the memory 2250 may store game-related information.

According to an embodiment, the processor 2210 may execute a method of providing a game service by using the program stored in the memory 2250.

According to an embodiment, the memory 2250 may include at least one type of storage medium among a flash memory type, a hard disk type, a multimedia card micro type, a card type memory (for example, a secure digital (SD) or an extreme digital (XD) memory), a random-access memory (RAM), a static RAM (SRAM), a read-only memory (ROM), an electrically erasable programmable ROM (EEPROM), a programmable ROM (PROM), a magnetic memory, a magnetic disk, and an optical disk. Also, according to an embodiment, the programs stored in the memory 2250 may be classified into a plurality of modules according to functions.

According to an embodiment, the user interface 2270 may include various interfaces. For example, the user interface 2270 may include any interface, such as a key pad, a dome switch, a speech input interface, a fingerprint input interface, and a touch input interface (contact capacitive type, pressure resistive type, infrared detection type, surface ultrasonic conduction type, integrated tension measurement type, or piezo-effect type), a camera, a jog wheel, or a jog switch, and may be link any sensor, such as an acceleration sensor, a position sensor, a temperature sensor, or an optical sensor to a user interface. Obviously, the disclosure is not limited to the above examples.

According to an embodiment, the user interface 2270 may further include an output unit (not shown). The output unit may include at least one of a liquid crystal display, a thin-film transistor-liquid crystal display, an organic light-emitting diode, a flexible display, a 3-dimensional (3D) display, and an electrophoretic display. When the output unit is configured as a touch screen as a display and a touch pad form a layer structure, the output unit may be used as an input device as well as an output device. The output unit may include a light-emitting diode (LED) lamp, a vibration motor, a speaker, or a flash, but is not limited thereto.

According to an embodiment, the user interface 2270 may output a notification about game information through an image, a moving image, sound, vibration, or a lamp. According to an embodiment, the user interface 2270 may include user interfaces described above with reference to FIGS. 6 to 11, 13, 15 to 17, and 19.

A method of providing a game service, according to various embodiments, may improve immersion of a user in a game by providing the game service such that a boundary between the game and reality is blurred.

The apparatus described above may be realized by a hardware component, a software component, and/or a combination of a hardware component and a software component. For example, the apparatus and component described in embodiments may be realized by using one or more general-purpose computers or special purpose computers, such as a processor, a controller, an arithmetic logic unit (ALU), a digital signal processor, a micro-computer, a field programmable gate array (FPGA), a programmable logic unit (PLU), a micro-processor, or any other device capable of executing and responding to an instruction. A processing device may execute an operating system (OS) and one or more software applications executed on the OS. Also, the processing device may access, store, manipulate, process, and generate data in response to execution of software. For convenience of description, it has been described that one processing device is used, but it would be obvious to one of ordinary skill in the art that the processing device may include a plurality of processing elements and/or a plurality of types of processing elements. For example, the processing device may include a plurality of processors or one processor and one controller. Also, another processing configuration, such as a parallel processor, is possible.

The software may include a computer program, a code, an instruction, or a combination thereof, and may configure the processing device to operate as desired or instruct the processing device independently or collectively. The software and/or data may be embodied, permanently or temporarily, by any type of machine, component, physical device, virtual equipment, computer storage medium or device, or transmitted signal wave, such as to be analyzed by the processing device or provided to the processing device. The software may be distributed on a computer system connected to a network, and stored or executed in a distributed manner. The software and data may be stored in one or more computer-readable recording media.

Methods according to embodiments may be recorded on a computer-readable recording medium by being implemented in the form of program commands executed by using various computers. The computer-readable recording medium may include at least one of a program command, a data file, and a data structure, independently or collectively. The program commands recorded in the computer-readable recording medium may be specially designed for an embodiment or well known to one of ordinary skill in the computer software field. Examples of the computer-readable recording medium include magnetic media such as hard disks, floppy disks, and magnetic tapes, optical media such as CD-ROMs and DVDs, magneto-optical media such as floptical disks, and hardware devices specially configured to store and perform program commands, such as read-only memory (ROM), random-access memory (RAM), and flash memory. Examples of the computer command include machine codes generated by a compiler, and high-level language codes executable by a computer by using an interpreter. The hardware device may be configured to operate as one or more software modules to perform operations of an embodiment, or vice versa.

As above, embodiments have been described by the limited examples and drawings, but various changes and modifications are possible from the above description by one of ordinary skill in the art. For example, appropriate results may be achieved even when the described techniques are performed in an order different from the described method, and/or components, such as a system, a structure, a device, and a circuit, are combined or associated in a form different from the described method, or replaced by other components or equivalents.

Therefore, other implementations, other embodiments, and equivalents of claims are also within the scope of the claims described below.

What is claimed is:

1. A method by which a game-providing apparatus provides a game service, the method comprising:
obtaining prerequisite information pre-defined for playing a game;
obtaining first content produced by setting a specific person as a recipient, based on the prerequisite information;
requesting an external server configured to provide an external service, to display the first content through the external service;
obtaining a first answer input by a user, based on the first content; and
providing a game service controlled based on the first answer.

2. The method of claim 1, wherein the obtaining of the first content comprises:
obtaining first situation information about a situation faced by the user in the game service; and
obtaining the first content, based on the prerequisite information and the first situation information.

3. The method of claim 2, further comprising:
obtaining second situation information about a situation faced by the user in the game service;
obtaining second content produced by setting the specific person as the recipient, based on the prerequisite information and the second situation information;
requesting the external server to display the second content through the external service;
obtaining, from the external server, a second answer input by the user, based on the second content; and
providing the game service controlled based on each of the first answer and the second answer.

4. The method of claim 1, wherein the obtaining of the first content comprises:
obtaining sender information about a sender of the first content;
obtaining first situation information about a situation faced by the user in the game service; and
obtaining the first content transmitted from the sender to the recipient, based on the prerequisite information, the sender information, and the first situation information.

5. The method of claim 4, further comprising:
obtaining a user input of pre-content transmitted from the recipient to the sender; and
requesting the external server to display the pre-content through the external service,
wherein the first situation information is obtained based on the pre-content.

6. The method of claim 1, wherein the first content comprises at least one of an image, video, text, and speech.

7. The method of claim 1, wherein the obtaining of the first answer comprises receiving, from the external server, the first answer obtained in the external service.

8. The method of claim 1, wherein the first answer comprises at least one of text and speech.

9. The method of claim 1, further comprising:
obtaining real life data related to a real life person corresponding to at least one character in the game service; and
changing the prerequisite information, based on the real life data.

10. A game-providing apparatus comprising:
a memory storing instructions; and
at least one processor functionally connected to the memory and configured to execute the instructions to:
obtain prerequisite information pre-defined for playing a game;
obtain first content produced by setting a specific person as a recipient, based on the prerequisite information;
request an external server configured to provide an external service, to display the first content through the external service;
obtain a first answer input by a user, based on the first content; and
provide a game service controlled based on the first answer.

11. The game-providing apparatus of claim 10, wherein the at least one processor is further configured to execute the instructions to:
obtain first situation information about a situation faced by the user in the game service; and
obtain the first content, based on the prerequisite information and the first situation information.

12. The game-providing apparatus of claim 11, wherein the at least one processor is further configured to execute the instructions to:
obtain second situation information about a situation faced by the user in the game service;
obtain second content produced by setting the specific person as the recipient, based on the prerequisite information and the second situation information;
request the external server to display the second content through the external service;
obtain, from the external server, a second answer input by the user, based on the second content; and
provide the game service controlled based on each of the first answer and the second answer.

13. The game-providing apparatus of claim 10, wherein the at least one processor is further configured to execute the instructions to:
obtain sender information about a sender of the first content;
obtain first situation information about a situation faced by the user in the game service; and
obtain the first content transmitted from the sender to the recipient, based on the prerequisite information, the sender information, and the first situation information.

14. The game-providing apparatus of claim 13, wherein the at least one processor is further configured to execute the instructions to:
obtain a user input of pre-content transmitted from the recipient to the sender; and
request the external server to display the pre-content through the external service,
wherein the first situation information is obtained based on the pre-content.

15. The game-providing apparatus of claim 10, wherein the first content comprises at least one of an image, video, text, and speech.

16. The game-providing apparatus of claim 10, wherein the at least one processor is further configured to execute the instructions to receive, from the external server, the first answer obtained in the external service.

17. The game-providing apparatus of claim 10, wherein the first answer comprises at least one of text and speech.

18. The game-providing apparatus of claim 10, wherein the at least one processor is further configured to execute the instructions to:
obtain real life data related to a real life person corresponding to at least one character in the game service; and
change the prerequisite information, based on the real life data.

19. A server comprising:
a memory storing instructions; and
at least one processor functionally connected to the memory and configured to execute the instructions to:
obtain prerequisite information pre-defined for playing a game;
obtain first content produced by setting a specific person as a recipient, based on the prerequisite information;
request an external server configured to provide an external service, to display the first content through the external service;
obtain a first answer input by a user, based on the first content; and
provide a game service controlled based on the first answer.

20. A user terminal for providing a game service, the user terminal comprising:
a user input unit configured to receive a user input;
a memory storing instructions; and
at least one processor functionally connected to the user input unit and the memory, and configured to execute the instructions to:
obtain prerequisite information pre-defined for playing a game;
obtain first content produced by setting a specific person as a recipient, based on the prerequisite information;
request an external server configured to provide an external service, to display the first content through the external service;
obtain a first answer input by a user, based on the first content; and
provide a game service controlled based on the first answer.

21. A computer-readable recording medium having recorded thereon a program for executing, on a computer, a method comprising:
obtaining prerequisite information pre-defined for playing a game;
obtaining first content produced by setting a specific person as a recipient, based on the prerequisite information;
requesting an external server configured to provide an external service, to display the first content through the external service;
obtaining a first answer input by a user, based on the first content; and
providing a game service controlled based on the first answer.
